(19) United States
(12) Patent Application Publication
(10) Pub. No.: US 2009/0087666 A1
(43) Pub. Date: Apr. 2, 2009

(54) CURABLE HIGH REFRACTIVE INDEX RESINS FOR OPTOELECTRONIC APPLICATIONS

(76) Inventors: Ramil-Marcelo L. Mercado, Rolla, MO (US); Robert V. Morford, Rolla, MO (US); Curtis Planje, Rolla, MO (US); Willie Perez, Chesterfield, MO (US); Tony D. Flaim, James, MO (US); Taylor R. Bass, Rolla, MO (US)

Correspondence Address: HOVEY WILLIAMS LLP, 10801 Mastin Blvd., Suite 1000, Overland Park, KS, 66210, US

(21) Appl. No.: 12/194,369

(22) Filed: Aug. 19, 2008

Related U.S. Application Data
(63) Continuation of application No. 11/235,619, filed on Sep. 26, 2005, now abandoned.
(60) Provisional application No. 60/614,017, filed on Sep. 28, 2004.

(51) Int. Cl. H01B 1/12; B05D 5/12; B32B 27/06; C08J 7/04

(52) U.S. Cl. 428/413; 427/58; 427/520; 252/500

(57) ABSTRACT

Novel compositions and methods of using those compositions to form high refractive index coatings are provided. The compositions preferably comprise both a reactive solvent and a high refractive index compound. Preferred reactive solvents include aromatic resins that are functionalized with one or more reactive groups (e.g., epoxides, vinyl ethers, oxetane), while preferred high refractive index compounds include aromatic epoxides, vinyl ethers, oxetanes, phenols, and thiols. An acid or crosslinking catalyst is preferably also included. The inventive compositions are stable under ambient conditions and can be applied to a substrate to form a layer and cured via light and/or heat application. The cured layers have high refractive indices and light transmissions.

### RELATED APPLICATIONS

The present application is a continuation of U.S. patent application Ser. No. 11/235,619, entitled CURABLE HIGH REFRACTIVE INDEX RESINS FOR OPTOELECTRONIC APPLICATIONS, filed Sep. 26, 2005, which claims the priority benefit of U.S. Provisional Patent Application No. 60/614,017, filed Sep. 28, 2004, each of which is incorporated by reference herein.

### BACKGROUND OF THE INVENTION

1. Field of the Invention

The present invention is broadly concerned with novel compositions that can be formed into high refractive index layers. The compositions are useful for forming solid-state devices such as flat panel displays, optical sensors, integrated optical circuits, light-emitting diodes (LEDs), microlens arrays, and optical storage disks.

2. Description of the Prior Art

High refractive index coatings offer a improved performance in the operation of many optoelectronic devices. For example, the efficiency of LEDs is improved by applying a layer of high refractive index material between the device and the encapsulating material, thereby reducing the refractive index mismatch between the semiconductor substrate and the surrounding encapsulating plastic. A higher refractive index material also allows lenses to have a higher numerical aperture (NA), which leads to increased performance.

Many organic polymer systems offer high optical transparency and ease of processing, but seldom provide high refractive indices. Furthermore, most of the UV-curable resins currently available are based on free radical polymerization. This method, while allowing for rapid curing, is sensitive to the presence of oxygen. Optically clear epoxy resins, on the other hand, are mostly cured by thermal methods, have long cure times, or suffer from short pot lives.

A need exists for curable compositions that have high refractive indices and high optical transparency for use in optical and photonic applications.

### SUMMARY OF THE INVENTION

The present invention overcomes these problems by providing novel compositions having high refractive indices and useful in the fabrication of optoelectronic components. The compositions broadly comprise a reactive solvent system (e.g., aromatic resin functionalized with one or more reactive groups such as epoxides, vinyl ethers, oxetanes) that dissolve a reactive high refractive index component such as aromatic epoxides, vinyl ethers, oxetanes, phenols, or thiols.

In more detail, the composition comprises a compound (I) having a formula selected from the group consisting of

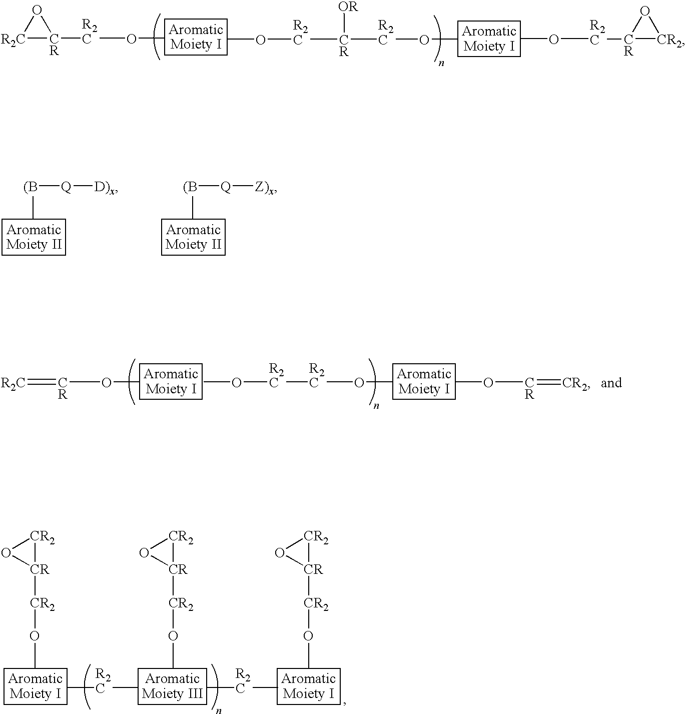

where:
each R is individually selected from the group consisting of hydrogen, alkyls (preferably from about C₁-C₁₀₀, more preferably from about C₁-C₂₀, and even more preferably from about C₁-C₁₂), alkoxys (preferably from about C₁-C₁₀₀, more preferably from about C₁-C₅₀, and even more preferably from about C₁-C₁₂), cycloaliphatics (preferably from about C₃-C₁₀₀, more preferably from about C₃-C₁₂, and even more preferably from about C₅-C₁₂), and aromatics (preferably from about C₃-C₁₀₀, more preferably from about C₃-C₅₀, and even more preferably from about C₅-C₁₂);
each B is individually selected from the group consisting of —CO—, —COO—, —CON—, —O—, —S—, —SO—, —SOr, —CR₂— and —NR—;
each Q is individually selected from the group consisting of —CR₂;
each D is individually selected from the group consisting of —VCRCR₂, where V is selected from the group consisting of —O— and —S—;
each Z is individually selected from the group consisting of

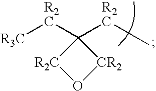

x is from about 0-6; and
n is from about 0-100, preferably from about 1-50, and even more preferably from about 1-40.

Preferred Aromatic Moieties I include those selected from the group consisting of

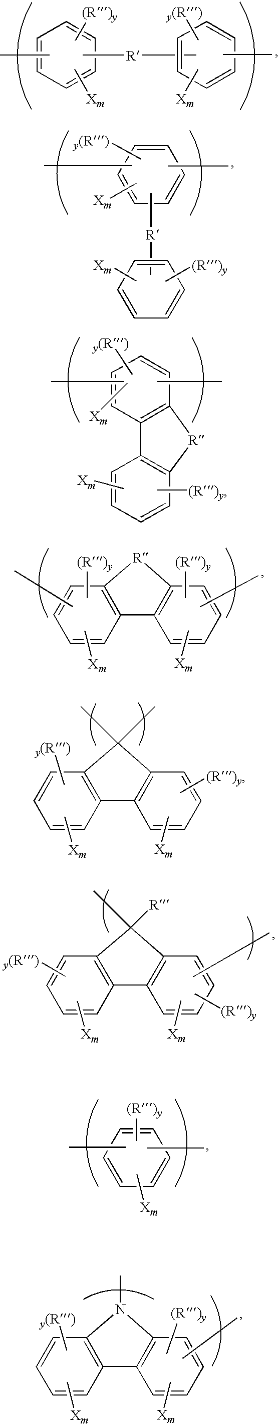

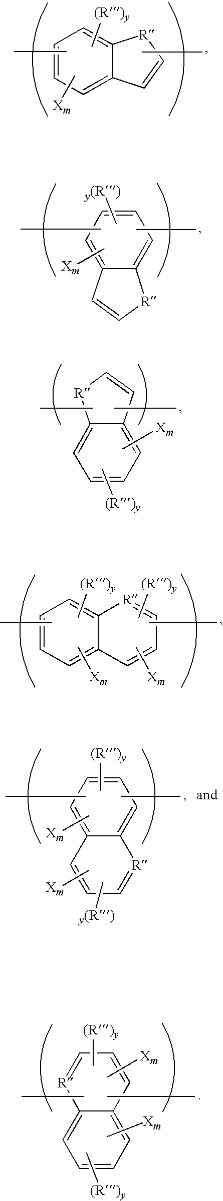

Preferred Aromatic Moieties II include those selected from the group consisting of

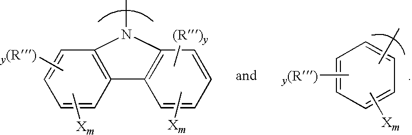

Preferred Aromatic Moieties III include those selected from the group consisting of

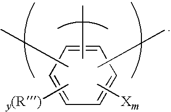

In each of the structures of Aromatic Moieties I, Aromatic Moieties II, and Aromatic Moieties III above, the variables are defined as follows:
each R′ is individually selected from the group consisting of —C(CR′″₃)₂—, —CR′″₂—, —SO₂—, —S—, —SO— and —CO—, where each R′″ is individually selected from the group consisting of hydrogen, alkyls (preferably from about C₁-C₁₀₀, more preferably from about C₁-C₂₀, and even more preferably from about C₁-C₁₂), alkoxys (preferably from about C₁-C₁₀₀, more preferably from about C₁-C₅₀, and even more preferably from about C₁-C₁₂), cycloaliphatics (preferably from about C₃-C₁₀₀, more preferably from about C₃-C₁₂, and even more preferably from about C₅-C₁₂), and aromatics (preferably from about C₃-C₁₀₀, more preferably from about C₃-C₅₀, and even more preferably from about C₅-C₁₂);
each R″ is individually selected from the group consisting of —CR′″₂—, —SO₂—, —SO—, —S—, —O—, —CO—, and —NR′″—, where each R′″ is individually selected from the group consisting of hydrogen, alkyls (preferably from about C₁-C₁₀₀, more preferably from about C₁-C₂₀, and even more preferably from about C₁-C₁₂), alkoxys (preferably from about C₁-C₁₀₀, more preferably from about C₁-C₅₀, and even more preferably from about C₁-C₁₂), cycloaliphatics (preferably from about C₃-C₁₀₀, more preferably from about C₃-C₁₂, and even more preferably from about C₅-C₁₂), and aromatics (preferably from about C₃-C₁₀₀, more preferably from about C₃-C₅₀, and even more preferably from about C₅-C₁₂);
each X is individually selected from the group consisting of the halogens (and most preferably Br and I);
each m is 0-6 and more preferably from about 1-2; and
each y is 0-6.

It will be understood that y can readily be selected by one of ordinary skill in the art, depending upon the value of m.

In preferred embodiments where the compound is acting as a reactive solvent. As used herein, a reactive solvent is one that reacts with the other compounds in the composition so as to be substantially (i.e., at least about 95% by weight, preferably at least about 99% by weight, and even more preferably about 100% by weight) consumed during the subsequent polymerization and crosslinking reactions. The reactive solvent also functions to dissolve the other ingredients in the composition to assist in homogenizing the composition.

In embodiments where the compound is acting as a high refractive index material, m will be at least 1. In order to achieve suitably high refractive indices, it is preferred that the X group be present in the compound to provide at least about 1%> by weight X groups, more preferably from about 5-80% by weight X groups, and even more preferably from about 30-70% by weight X groups, based upon the total weight of the composition taken as 100% by weight.

In a particular preferred embodiment, the composition will comprise both the compound as a reactive solvent (i.e., without X groups) and as a high refractive index material (i.e., with X groups). It is preferred that the reactive solvent compound be present at levels of at least about 1% by weight, preferably from about 5-95% by weight, and even more preferably from about 10-50% by weight, based upon the total weight of the composition taken as 100%> by weight. The high refractive index compound is preferably present at levels of at least about 1% by weight, preferably from about 5-95% by weight, and even more preferably from about 10-90%) by weight, based upon the total weight of the composition taken as 100% by weight.

The composition also preferably comprises a crosslinking catalyst. Preferred crosslinking catalysts are selected from the group consisting of acids, photoacid generators (preferably cationic), photobases, thermal acid generators, thermal base generators, and mixtures thereof. Examples of particularly preferred crosslinking catalysts include those selected from the group consisting of substituted trifunctional sulfonium salts (preferably where at least one functional group is an aryl group), iodonium salts, disulfoncs, triazines, diazomethanes, and sulfonates. The crosslinking catalyst should be included at levels of from about 1-15% by weight, preferably from about 1-10% by weight, and even more preferably from about 1-8% by weight, based upon the total weight of the reactive solvent and high refractive index material taken as 100% by weight.

In another embodiment, the composition preferably further comprises a compound selected from the group consisting of

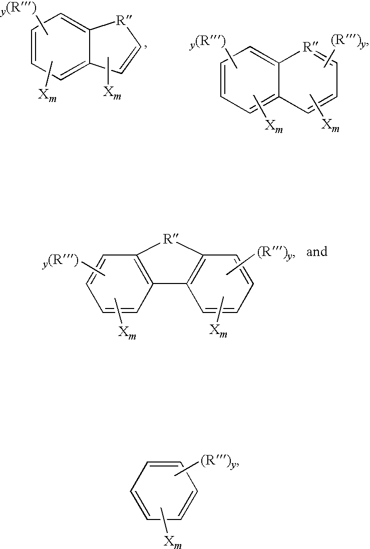

where:
each R″ is individually selected from the group consisting of —CR′″₂—, —SO₂—, —SO—, —S—, —O—, —CO—, and —NR′″—, where each R′″ is individually selected from the group consisting of hydrogen, alkyls (preferably from about C₁-C₁₀₀, more preferably from about C₁-C₂₀, and even more preferably from about C₁-C₁₂), alkoxys (preferably from about C₁-C₁₀₀, more preferably from about C₁-C₂₀, and even more preferably from about C₁-C₁₂), cycloaliphatics (preferably from about C₃-C₁₀₀, more preferably from about C₃-C₁₂, and even more preferably from about C₅-C₁₂), and aromatics (preferably from about C₂-C₁₀₀, more preferably from about C₃-C₅₀, and even more preferably from each X is individually selected from the group consisting of the halogens (and most preferably Br and I); and
each m is 0-6 and more preferably from about 1-2; and
each y is 0-6.

It will be understood that y can readily be selected by one of ordinary skill in the art, depending upon the value of m.

In a particularly preferred embodiment, the composition comprises very low levels of non-reactive solvents or diluents (e.g., PGME, PGMEA, propylene carbonate). Thus, the composition comprises less than about 5% by weight, preferably less than about 2% by weight, and even more preferably about 0% by weight non-reactive solvents or diluents, based upon the total weight of the composition taken as 100% by weight.

It will be appreciated that other optional ingredients can be included in the inventive compositions as well. Examples of some optional ingredients include fillers, UV stabilizers, and surfactants.

The inventive compositions are formed by heating the reactive solvent compound(s) until it achieves a temperature of from about 20-100° C., and more preferably from about 60-80° C. The high refractive index compound(s) are then added and mixing is continued until a substantially homogeneous mixture is obtained. The crosslinking catalyst and any other optional ingredients are then added and mixing is continued.

The compositions are applied to a substrate by any known method to form a coating layer or film thereon. Suitable coating techniques include dip coating, roller coating, injection molding, film casting, draw-down coating, or spray coating. A preferred method involves spin coating the composition onto the substrate at a rate of from about 500-5,000 rpm (preferably from about 1,000-4,000 rpm) for a time period of from about 30-480 seconds (preferably from about 60-300 seconds) to obtain uniform films. Substrates to which the coatings can be applied include those selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide (sapphire), glass, quartz, polycarbonates, polyesters, acrylics, polyurethanes, papers, ceramics, and metals (e.g., copper, aluminum, gold).

The applied coatings are then cured by either baking or exposing to light, having a wavelength effective for crosslinking the resin within the composition, depending upon the catalyst system utilized. If baked, the composition will be baked at temperatures of at least about 40° C., and more preferably from about 50-150° C. for a time period of at least about 5 seconds (preferably from about 10-60 seconds). Light exposure is the most preferred method of effecting curing of the composition because the most preferred inventive compositions are photocurable. In this curing method, light (e.g., at a wavelength of from about 100-1,000 nm (more preferably from about 240-400 nm) or at an exposure energy of from about 0.005-20 J/cm² (more preferably from about 0.1-10 J/cm²) is used to generate the acid that catalyzes the polymerization and crosslinking reactions.

Cured coatings prepared according to the instant invention will have superior properties, and can be formulated to have thicknesses of from about 1-5,000 μm. For example, the cured coatings will have a refractive index of at least about 1.5, preferably at least about 1.56, and more preferably at least about 1.60, at wavelengths of from about 375-1,700 nm. Furthermore, cured coatings having a thickness of about 100 μm will have a percent transmittance of at least about 80%, preferably at least about 90%, and even more preferably least about 95%> at wavelengths of from about 375-1700 nm.

### BRIEF DESCRIPTION OF THE DRAWINGS

FIG. 1 is a graph depicting the n and k values for a cured layer formed from the composition of Example 1;

FIG. 2 is a graph showing the percent of light transmission of a cured layer formed from the composition of Example 1;

FIGS. 3-3d are graphs demonstrating the light stability at different energy levels of a cured layer formed from the composition of Example 1;

FIGS. 4-4c are graphs demonstrating the thermal stability over time of a cured layer formed from the composition of Example 1;

FIG. 5 is a graph depicting the n and k values for a cured layer formed from the composition of Example 2;

FIG. 6 is a graph showing the percent of light transmission of a cured layer formed from the composition of Example 2;

FIGS. 7-7c are graphs demonstrating the light stability at different energy levels of a cured layer formed from the composition of Example 2:

FIGS. 8-8c are graphs demonstrating the thermal stability over time of a cured layer formed from the composition of Example 2;

FIG. 9 is a graph depicting the n and k values for a cured layer formed from the composition of Example 3;

FIG. 10 is a graph showing the percent of light transmission of a cured layer formed from the composition of Example 3;

FIG. 11 is a graph depicting the n and k values for a cured layer formed from the composition of Example 4;

FIG. 12 is a graph showing the percent of light transmission of a cured layer formed from the composition of Example 4;

FIG. 13 is a graph depicting the n and k values for a cured layer formed from the composition of Example 5;

FIG. 14 is a graph showing the percent of light transmission of a cured layer formed from the composition of Example 5;

FIG. 15 is a graph depicting the n and k values for a cured layer formed from the composition of Example 6:

FIG. 16 is a graph showing the percent of light transmission of a cured layer formed from the composition of Example 6;

FIG. 17 is a graph depicting the n and k values for a cured layer formed from the composition of Example 7;

FIG. 18 is a graph showing the percent of light transmission of a cured layer formed from the composition of Example 7;

FIG. 19 is a graph depicting the n and k values for a cured layer formed from the composition of Example 8;

FIG. 20 is a graph showing the percent of light transmission of a cured layer formed from the composition of Example 8;

FIG. 21 is a graph depicting the n and k values for a cured layer formed from the composition of Example 9;

FIG. 22 is a graph showing the percent of light transmission of a cured layer formed from the composition of Example 9;

FIG. 23 is a graph depicting the n and k values for a cured layer formed from the composition of Example 10;

FIG. 24 is a graph showing the percent of light transmission of a cured layer formed from the composition of Example 10;

FIG. 25 is a graph depicting the n and k values for a cured layer formed from the composition of Example 11;

FIG. 26 is a graph showing the percent of light transmission of a cured layer formed from the composition of Example 11;

FIG. 27 is a graph depicting the n and k values for a cured layer formed from the composition of Example 12;

FIG. 28 is a graph showing the percent of light transmission of a cured layer formed from the composition of Example 12;

FIG. 29 is a graph depicting the n and k values for a cured layer formed from the composition of Example 13;

FIG. 30 is a graph showing the percent of light transmission of a cured layer formed from the composition of Example 13;

FIG. 31 is a graph depicting the n and k values for a cured layer formed from the composition of Example 14;

FIG. 32 is a graph showing the percent of light transmission of a cured layer formed from the composition of Example 14;

FIG. 33 is a graph depicting the n and k values for a cured layer formed from the composition of Example 15;

FIG. 34 is a graph showing the percent of light transmission of a cured layer formed from the composition of Example 15;

FIG. 35 is a graph depicting the n and k values for a cured layer formed from the composition of Example 16;

FIG. 36 is a graph showing the percent of light transmission of a cured layer formed from the composition of Example 16;

FIG. 37 is a graph depicting the n and k values for a cured layer formed from the composition of Example 17:

FIG. 38 is a graph showing the percent of light transmission of a cured layer formed from the composition of Example 17;

FIG. 39 is a graph depicting the n and k values for a cured layer formed from the composition of Example 18;

FIG. 40 is a graph showing the percent of light transmission of a cured layer formed from the composition of Example 18;

FIG. 41 is a graph depicting the n and k values for a cured layer formed from the composition of Example 19;

FIG. 42 is a graph showing the percent of light transmission of a cured layer formed from the composition of Example 19;

FIG. 43 is a graph depicting the n and k values for a cured layer formed from the composition of Example 20;

FIG. 44 is a graph showing the percent of light transmission of a cured layer formed from the composition of Example 20;

FIG. 45 is a graph depicting the n and k values for a cured layer formed from the composition of Example 21; and

FIG. 46 is a graph showing the percent of light transmission of a cured layer formed from the composition of Example 21.

### DETAILED DESCRIPTION OF THE PREFERRED EMBODIMENTS

### Examples

The following examples set forth preferred methods in accordance with the invention. It is to be understood, however, that these examples are provided by way of illustration and nothing therein should be taken as a limitation upon the overall scope of the invention.

### Example 1

A Curable High Refractive Index Resin Prepared with Aromatic Epoxides

### A. Preparation of Formulation 1

The following procedure was used to a prepare a curable high refractive index coating:
1. An oil bath was preheated to 80° C. (oil temperature).
2. Approximately 50.00 grams of Dow D.E.R. 332 (Dow Plastics) were added to a 250-mL round-bottom flask. The amount used equaled the amount of Dow D.E.R. 560 (Dow Plastics) used in Step 4 below.
3. The round-bottom flask and its contents were heated to about 60-70° C. while being stirred with a stir bar or mechanical stirrer.
4. Once the desired temperature was reached, Dow D.E.R. 560 (50.00 grams—an amount equal to the Dow D.E.R. 332 used in Step 2 above) was weighed out and slowly added to the stirring Dow D.E.R. 332.
5. The mixture was then stirred for 2 hours, or until both compounds were mixed.
6. Dow UVI-6976 (The Dow Chemical Company) was added in an amount of 2% by weight, based upon the combined weight of Dow D.E.R. 332 and Dow D.E.R. 550 taken as 100% by weight.
7. The mixture was allowed to cool slightly and then poured into an appropriate container.
   B. Preparation of Films from Formulation 1

Using normal spin-coating techniques, Formulation 1 could be coated onto various types of wafers (silicon, quartz, glass, etc.). A typical spin-coating and UV-curing process is described in the following:
1. To spin coat the formulation onto a wafer, a CEE 100CB Spinner/Hotplate (Brewer Science Inc.) was used. Spin speeds ranged from 1,000-5,000 rpm. Acceleration ranged from 500-20,000 rpm/sec. Spin times ranged from 90-360 seconds.
2. A Canon PLA-501F Parallel Light Mask Aligner with xenon lamp was used to cure the films. Output was 3.7 mJ-sec/cm² at 365 nm. Exposure times ranged from 10-12 minutes. Total exposure doses ranged from 1.2-2.7 J/cm².

Table 1 below shows representative film processing data specifically for these materials.

TABLE 1

| | Spin | Spin | Ramp | | Exposure | |
|---|---|---|---|---|---|---|
| Wafer | Speed | Time | Rate | | Dose | Thickness |
| # | (rpm) | (sec) | (rpm/sec) | Bake | (J/cm²) | (μm) |
| 1 | 1,000 | 360 | 4,500 | 15 sec | 2.0 | 550 |
| | | | | at 100° C. | | |
| 2 | 2,000 | 360 | 4,500 | 15 sec | 2.0 | 275 |
| | | | | at 100° C. | | |
| 3 | 3,000 | 360 | 4,500 | 15 sec | 2.0 | 180 |
| | | | | at 100° C. | | |
| 4 | 4,000 | 360 | 4,500 | 15 sec | 2.0 | 150 |
| | | | | at 100° C. | | |
| 5 | 5,000 | 360 | 4,500 | 15 sec | 2.0 | 120 |
| | | | | at 100° C. | | |

The data in Table 2 were obtained through the analysis of the above films by use of a prism coupler (Metricon 2010).

TABLE 2

| | Refractive | Refractive | Refractive |
|---|---|---|---|
| | Index | Index | Index |
| Wafer # | at 401 nm | at 633 nm | at 780 nm |
| 1 | 1.6446 | 1.6032 | 1.5953 |
| 2 | 1.6444 | 1.6032 | 1.5955 |
| 3 | 1.6450 | 1.6035 | 1.5959 |
| 4 | 1.6446 | 1.6030 | 1.5957 |
| 5 | 1.6448 | 1.6039 | 1.5955 |

Refractive index (n) and extinction coefficient (k) data (see FIG. 1) were obtained using a variable angle spectroscopic ellipsometer (VASE, H-VASE, J. A. Woollam Company).

A Varian Gary 500 Scan UV-Vis-NIR Dual Beam Spectrophotometer was used to measure the light transmission quality of the films. The mode used was nanometers, with a range of 200 to 3,300 nm. For the scan controls, the average time was 0.1 second, the data interval was 1.0 nm, and the scan rate was 600 nm/min. The Y mode parameters were Y min= 0.00, and Y max 100.00. The baseline parameter was zero/baseline.

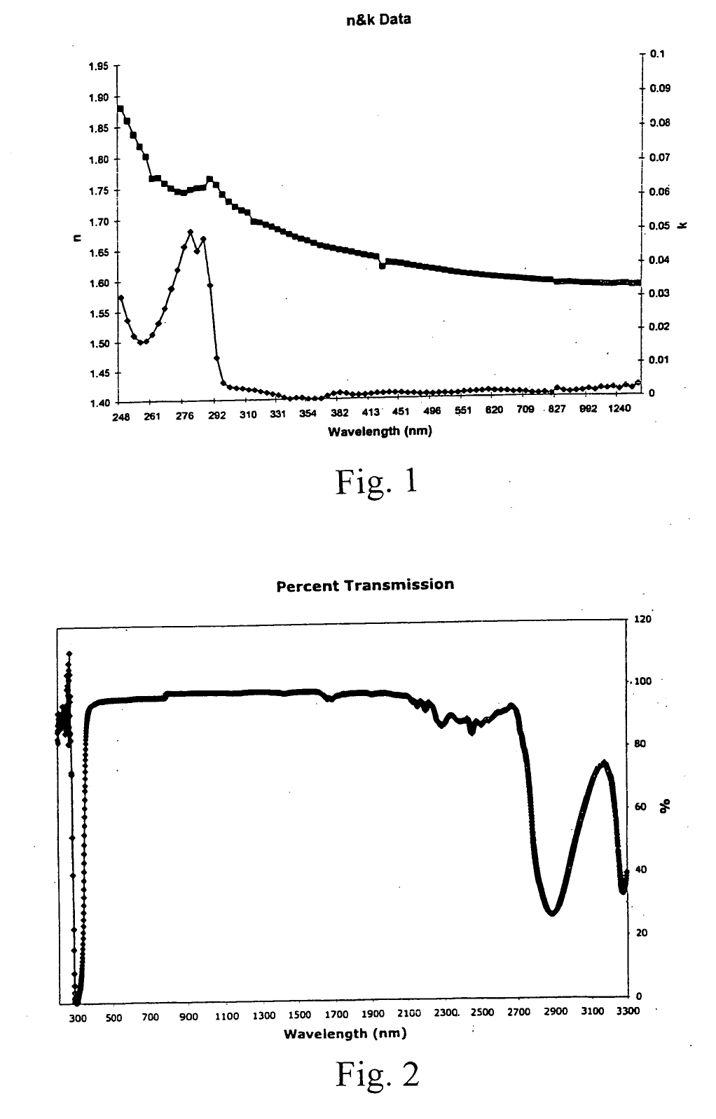

The graph of FIG. 2 shows the percent of light transmission (%T) of the films obtained using the parameters described above.

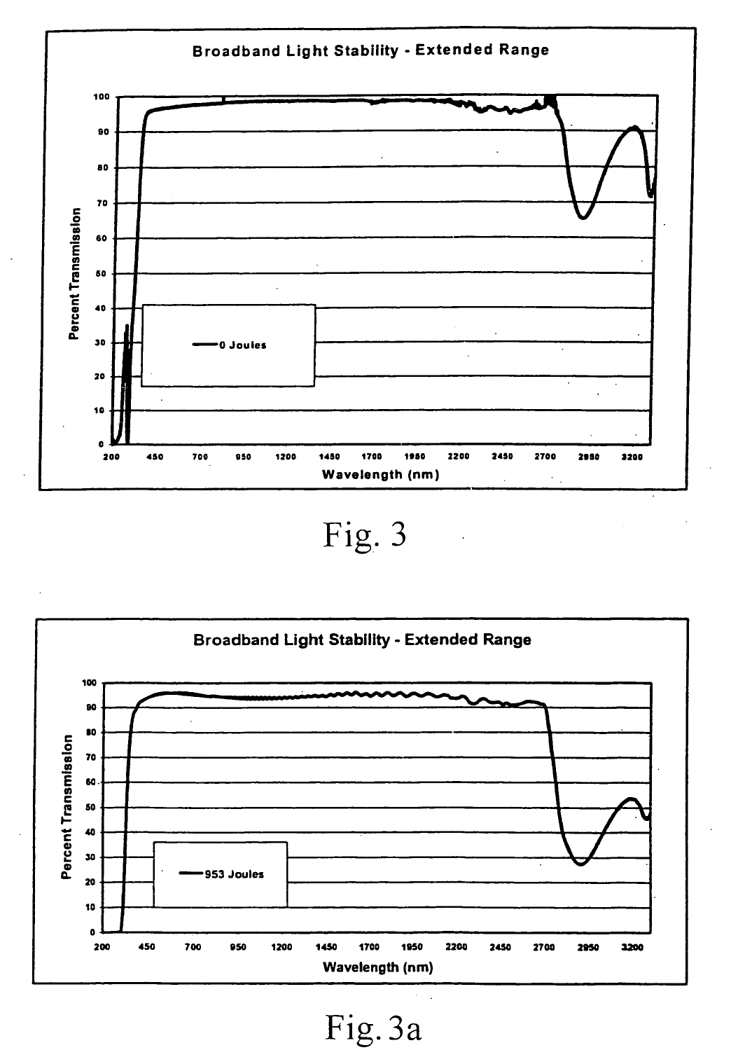

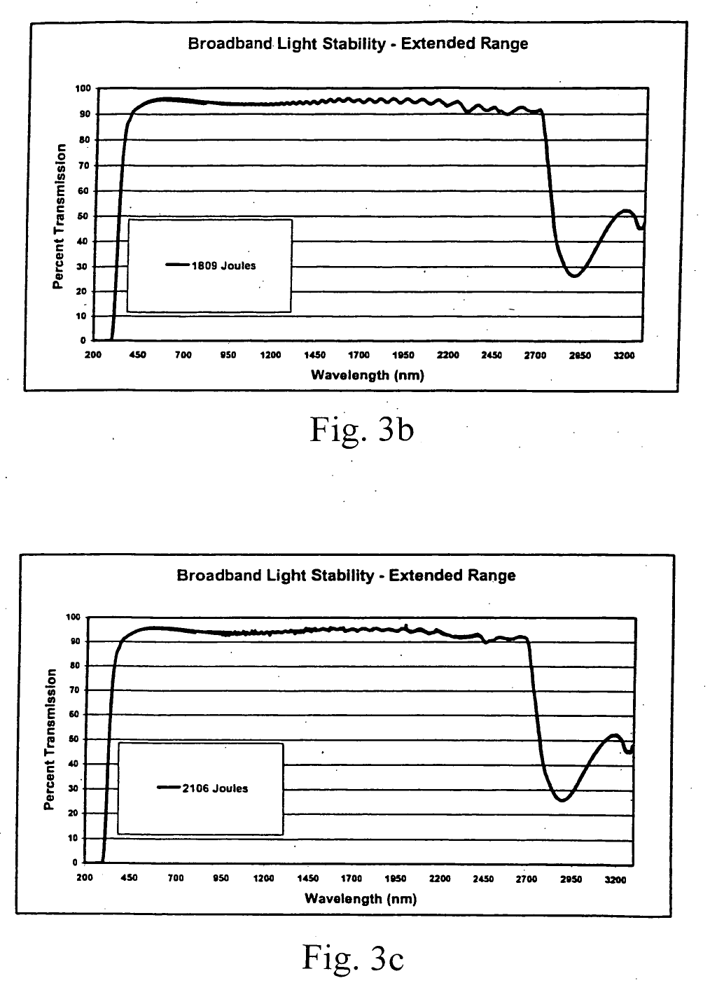

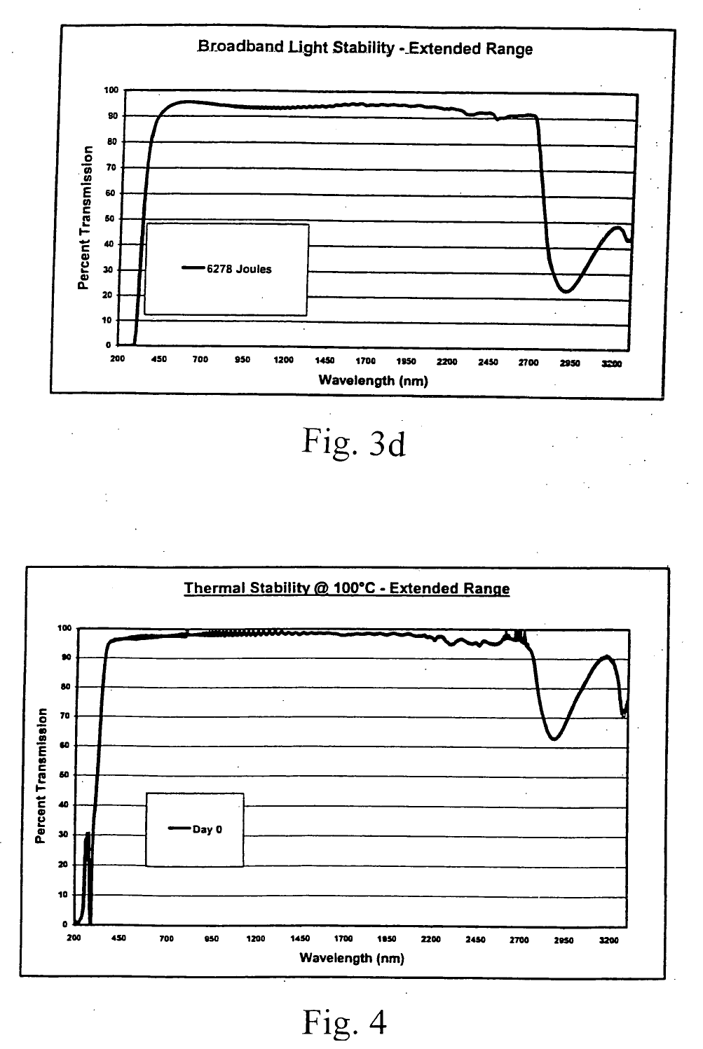

Light stability measurements were performed using a Canon PLA-501F Parallel Light Mask Aligner with xenon lamp with an average output of 2.45 mJ-sec/cm² at 365 nm. The total exposure dose at 365 nm was 2.265 Joules. Film transmission, expressed as a percentage, is shown in FIG. 3.

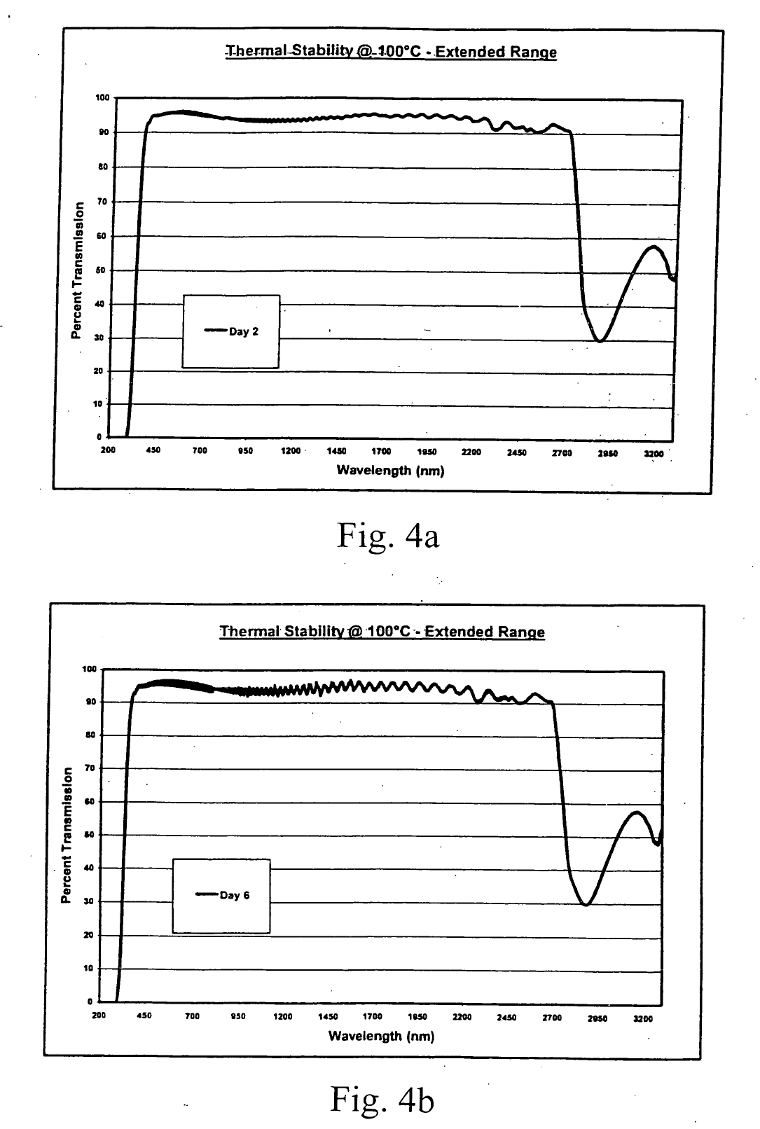

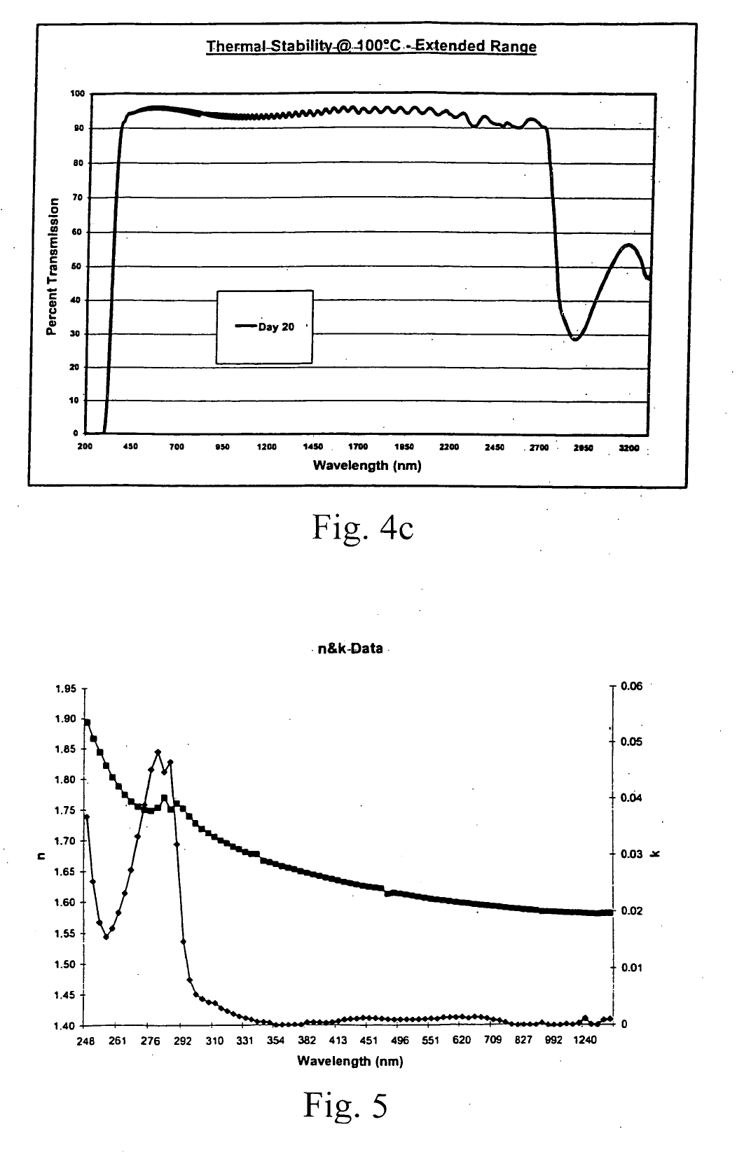

Thermal stability of the film was investigated using a Blue M Electric Company Convection Oven, Model ESP-400BC-4, and subjecting the cured films to a temperature of 100° C. for 20 days. Film transmission, expressed as a percentage, is shown in FIG. 4.

### Example 2

### Curable High Refractive Index Resin Prepared with Epoxides and a Brominated Epoxy Novolac Resin

### A. Preparation of Formulation 2

The following procedure was used to prepare a curable high refractive index coating:
1. An oil bath was preheated to 80° C. (oil temperature).
2. Approximately 40.00 grams of Dow D.E.R. 332 were added to a 250-mL round-bottom flask.
3. The flask and its contents were heated to about 60-70° C. while being stirred with a stir bar or mechanical stirrer.
4. Once the desired temperature was reached, 60.00 grams of BREN 304 (Nippon Kayaku Company, Ltd.) were weighed out and slowly added to the stirring Dow D.E.R. 332.
5. The contents of the flask were stirred for 2 hours or until both compounds were mixed.
6. Dow UVI-6976 (The Dow Chemical Company) was added in an amount of 2% by weight, based upon the combined weight of the Dow D.E.R. 332 and (Nippon Kayaku Company, Ltd.) taken as 100% by weight.
7. The contents of the flask were then allowed to mix for 30-45 minutes.
8. The mixture was allowed to cool slightly and then poured into an appropriate container.
   B. Preparation of Films from Formulation 2

Using normal spin-coating and UV-curing techniques, the formulation can be coated onto various types of wafers (silicon, quartz, glass, etc.). A CEE 100CB Spinner/Hotplate was used to apply Formulation 2 to wafers. The spin speed was 1,000-5,000 rpm, acceleration was 4,500 rpm/sec, and the spin time was 420 seconds.

To cure the films, a Canon PLA-501F Parallel Light Mask Aligner with xenon lamp was used. Output was 2.7 mJ-sec/cm² at 365 nm. Time was 10-12 minutes. Total exposure doses ranged from 1.2-2.7 J/cm²

Representative film processing data for these materials are shown in Table 3.

TABLE 3

| | Spin | Ramp | Spin | | Exposure | |
|---|---|---|---|---|---|---|
| | Speed | Rate | Time | | Dose | Thickness |
| Wafer # | (rpm) | (rpm/sec) | (sec) | Bake | (J/cm²) | (μm) |
| 1 | 1,000 | 4,500 | 420 | 15 sec | 2.0 | 460 |
| | | | | at 100° C. | | |
| 2 | 2,000 | 4,500 | 420 | 15 sec | 2.0 | 200 |
| | | | | at 100° C. | | |
| 3 | 3,000 | 4,500 | 420 | 15 sec | 2.0 | 70 |
| | | | | at 100° C. | | |
| 4 | 4,000 | 4,500 | 420 | 15 sec | 2.0 | 50 |
| | | | | at 100° C. | | |
| 5 | 5,000 | 4,500 | 420 | 15 sec | 2.0 | 4 |
| | | | | at 100° C. | | |

The data in Table 4 were obtained through the analysis of the above films by using a prism coupler (Metricon 2010).

TABLE 4

| | Refractive | Refractive | Refractive |
|---|---|---|---|
| | Index | Index | Index |
| Wafer # | at 401 nm | at 633 nm | at 780 nm |
| 1 | N/A | 1.6091 | 1.6013 |
| 2 | 1.6515 | 1.609 | 1.6011 |
| 3 | N/A | 1.6086 | 1.6006 |
| 4 | N/A | 1.6086 | 1.6008 |
| 5 | N/A | 1.609 | 1.6006 |

The refractive index (n) and extinction coefficient (k) data (see FIG. 5) were obtained using a variable angle spectroscopic ellipsometer (VASE, H-VASE, J.A. Woollam Company).

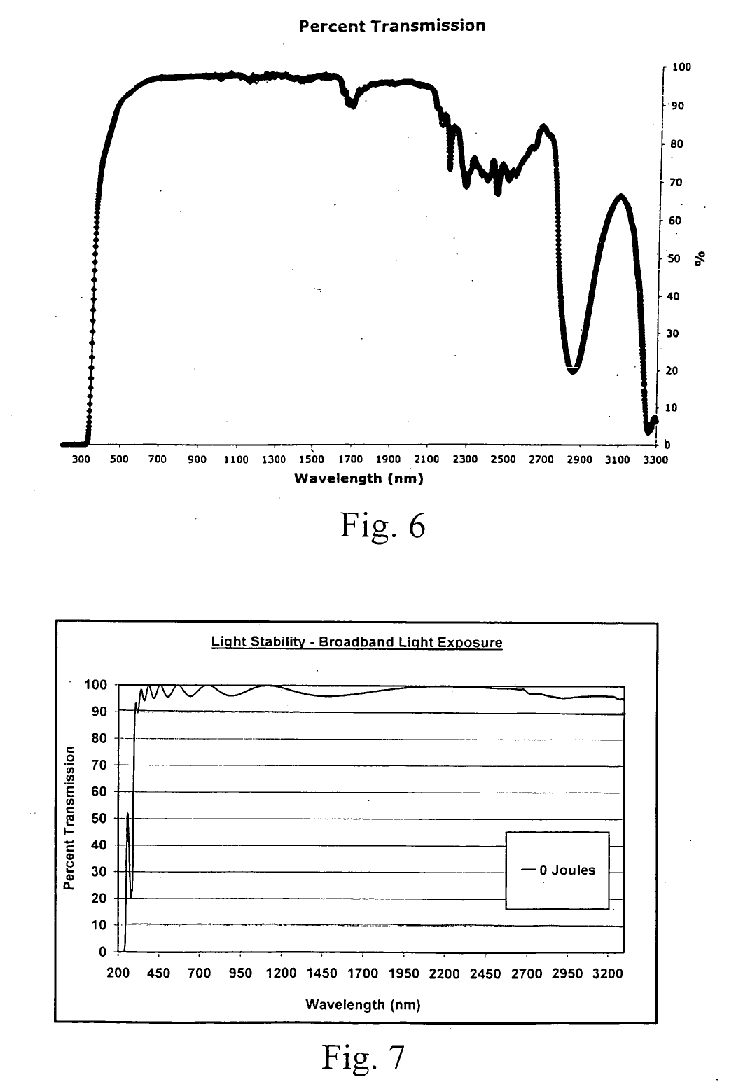

The transmission data of the films, shown in the graph of FIG. 6 and expressed as a percentage, were obtained using a Varian Cary 500 Scan UV-Vis-NIR Dual Beam Spectrophotometer. The mode used was nanometers, with a range of 200-3,300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

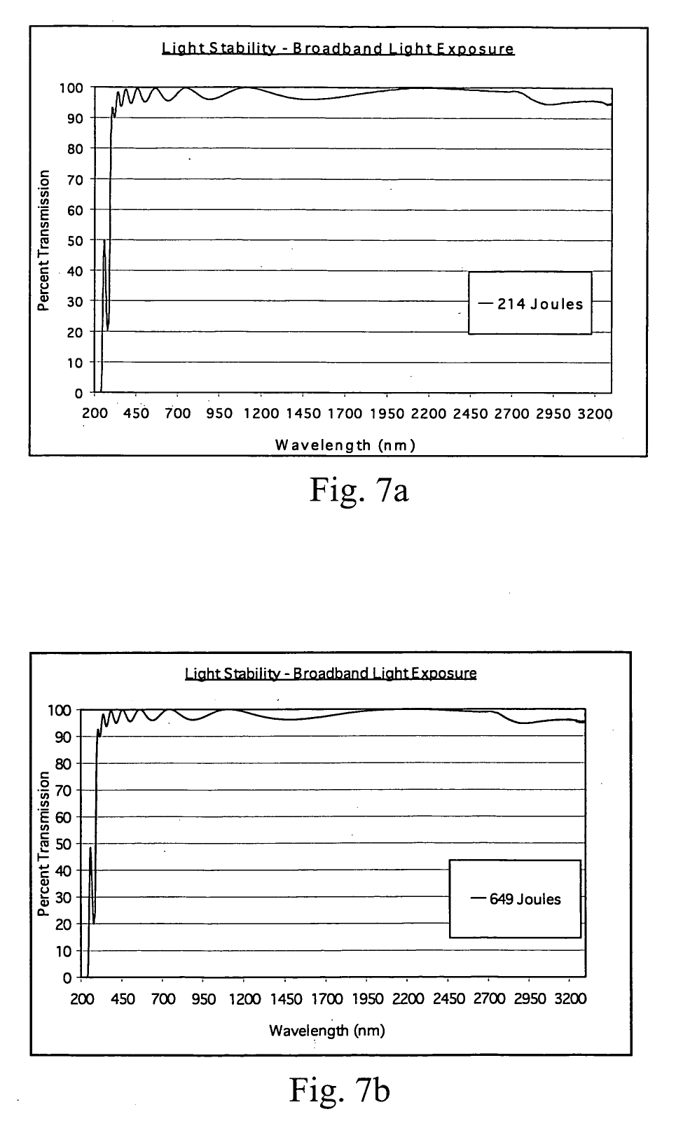

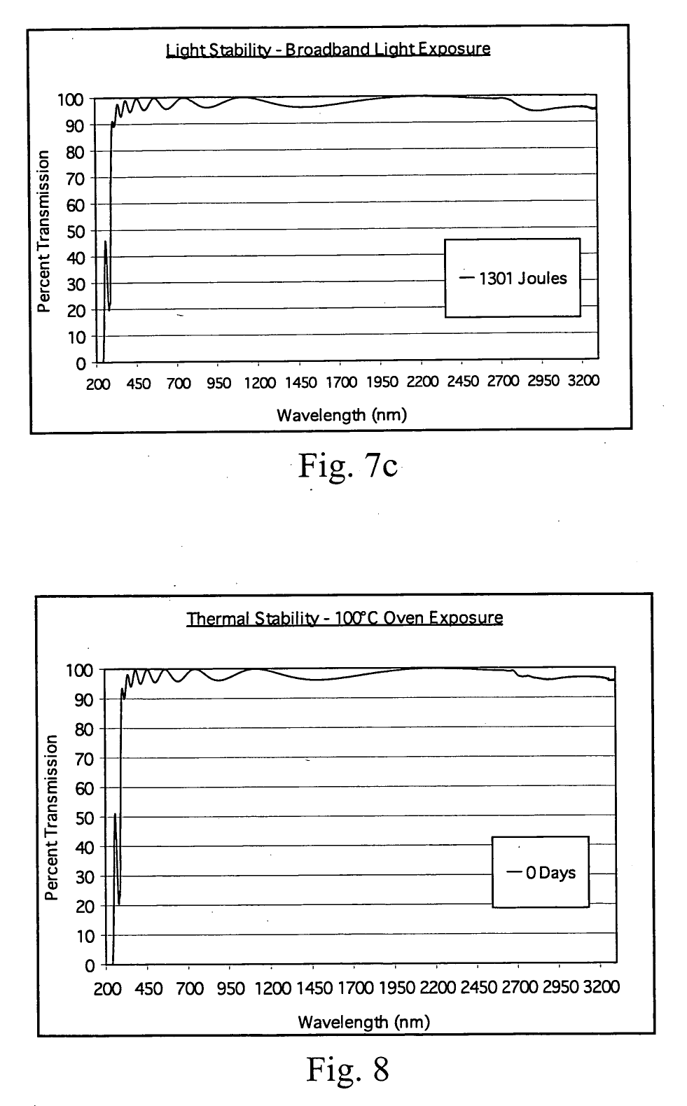

Light stability measurements were performed using a Canon PLA-501F Parallel Light Mask Aligner with xenon lamp, with an average output of 2.45 mJ-sec at 365 nm and a total exposure dose at 365 nm of 2265 Joules. The film transmission, expressed as a percentage, is shown in FIG. 7.

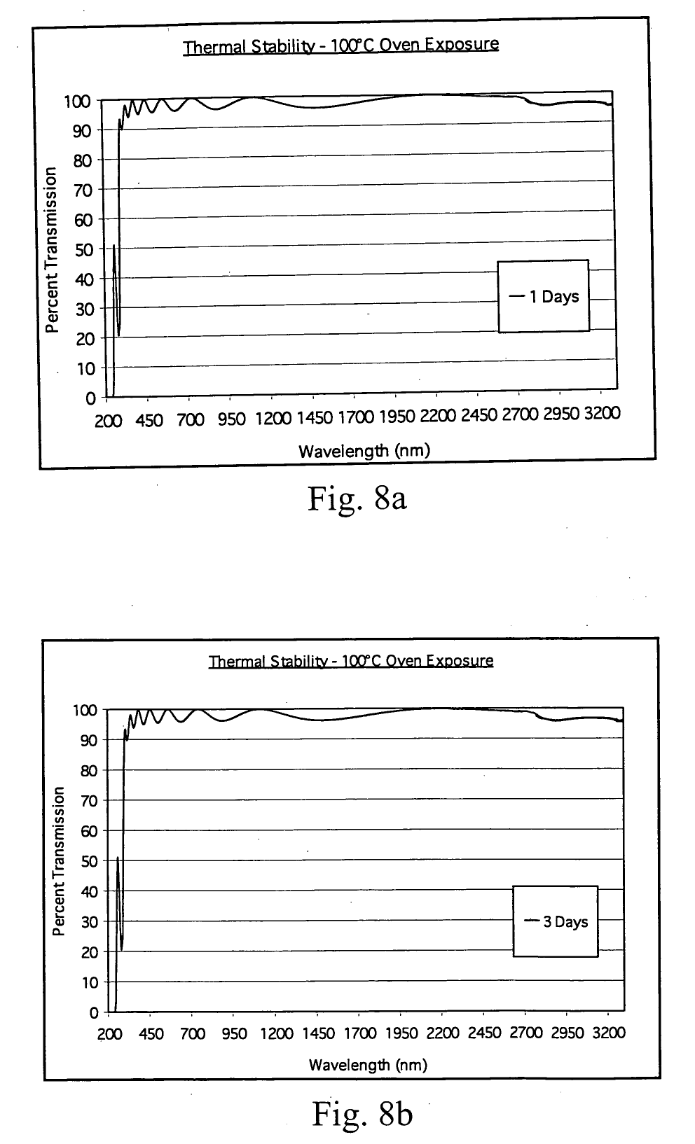

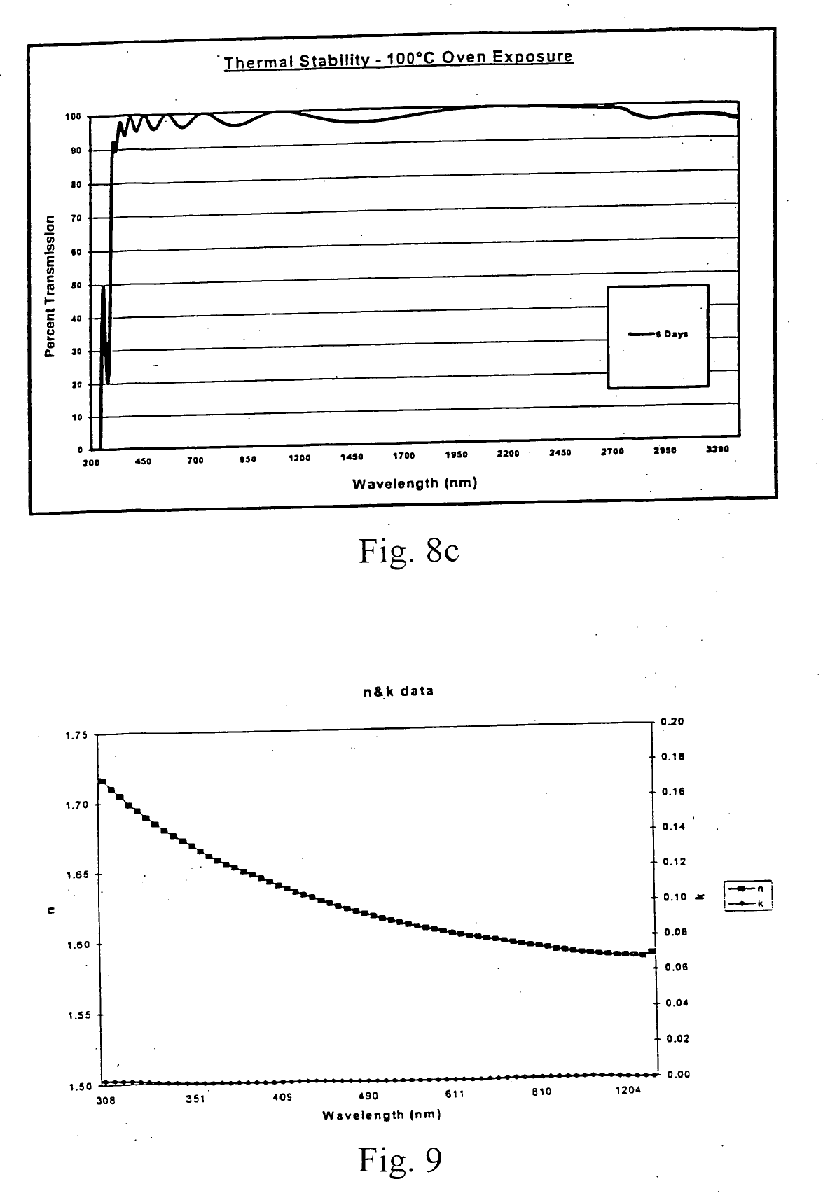

The thermal stability of the film was investigated using a Blue M Electric Company Convection Oven, Model ESP-400BC-4, and subjecting the cured films to a temperature of 100° C. for 6 days. The film transmission, expressed as a percentage, is shown in FIG. 8.

### Example 3

### A Curable High Refractive Index Resin Prepared with Aromatic Epoxides and an Aromatic Epoxy Diluent

### A. Preparation of Formulation 3

The following procedure was used to prepare a curable high refractive index coating:
1. An oil bath was preheated to 80° C. (oil temperature).
2. Approximately 43.93 grams of Dow D.E.R. 332 and 10.04 g ERISYS GE-10 (CVC Chemical Specialties Inc.) were added to a 250-mL round-bottom flask.
3. The flask and its contents were heated to about 60-70° C. while being stirred with a stir bar or mechanical stirrer.
4. Once the desired temperature was reached, 44.00 grams of Dow D.E.R. 560 were slowly added to the stirring Dow D.E.R. 332 and ERISYS GE-10 mixture.
5. The contents of the flask were stirred for 2 hours or until all compounds were mixed.
6. Dow UVI-6976 (The Dow Chemical Company) was added in an amount of 2% by weight, based upon the combined weight of the ingredients already added taken as 100% by weight.
7. The contents of the flask were then allowed to mix for 2.5 hours.
8. The mixture was allowed to cool slightly and then poured into an appropriate container.
   B. Preparation of Films from Formulation 3

Using normal spin-coating and UV-curing techniques, the formulation can be coated onto various types of wafers (silicon, quartz, glass, etc.). A CEE 100CB Spinner/Hotplate was used to apply Formulation 3 to wafers. Spin speed was 1,000-5000 rpm, acceleration was 4,500 rpm/sec, and spin time was 60 seconds.

To cure the films, a Canon PLA-501F Parallel Light Mask Aligner with xenon lamp was used. The output was 2.7 mJ-sec/cm² at 365 nm, the time was 12 minutes, and the total exposure dose was 2.0 J/cm².

Representative film processing data for these materials are shown in Table 5.

TABLE 5

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.0 | 240 |
| 2 | 2,000 | 4,500 | 60 | 2.0 | 190 |
| 3 | 3,000 | 4,500 | 60 | 2.0 | 150 |
| 4 | 4,000 | 4,500 | 60 | 2.0 | 80 |
| 5 | 5,000 | 4,500 | 60 | 2.0 | 10 |

The data of Table 6 were obtained through the analysis of the above films by using a prism coupler (Metricon 2010).

TABLE 6

| | Refractive | Refractive | Refractive |
|---|---|---|---|
| | Index | Index | Index |
| Wafer # | at 401 nm | at 633 nm | at 780 nm |
| 1 | 1.6400 | 1.5992 | 1.5917 |
| 2 | 1.6404 | 1.5992 | 1.5918 |
| 3 | 1.6406 | 1.5992 | 1.5920 |
| 4 | 1.6404 | 1.5993 | 1.5922 |
| 5 | 1.6402 | 1.5993 | 1.5920 |

The refractive index (n) and extinction coefficient (k) data (see FIG. 9) were obtained using a variable angle spectroscopic ellipsometer (VASE, H-VASE, J.A. Woollam Company).

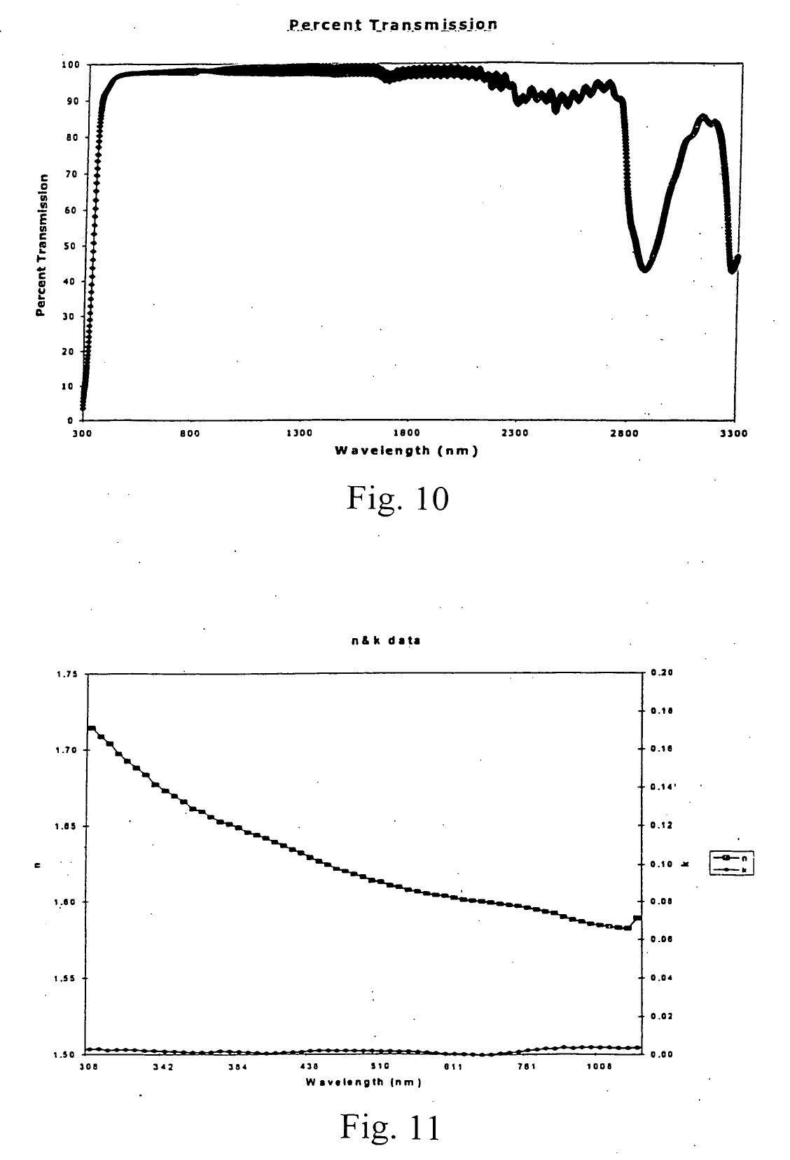

The transmission data of the films, shown in the graph of FIG. 10 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 4

### A Curable High Refractive Index Resin Prepared with Aromatic Epoxides and an Aromatic Vinyl Ether Diluent

### A. Preparation of Formulation 4

The following procedure was used to prepare a curable high refractive index coating:
1. An oil bath was preheated to 80° C. (oil temperature).
2. Approximately 44.98 grams of Dow D.E.R. 332 were added to a 250-mL round-bottom flask.
3. The flask and its contents were heated to about 60-70° C. while being stirred with a stir bar or mechanical stirrer.
4. Once the desired temperature was reached, 44.98 grams of Dow D.E.R. 560 were slowly added to the stirring Dow D.E.R. 332.
5. The contents of the flask were stirred for 1 hour until both compounds were mixed.
6. Next, 10.01 grams VECTOMER 4010 (available from Morflex) were added drop wise.
7. The mixture was stirred for 30 minutes.
8. Dow UVI-6976 (The Dow Chemical Company) was added in an amount of 2% by weight, based upon the combined weight of the ingredients already added taken as 100% by weight.
9. The contents of the flask were mixed for 60 minutes.
10. The mixture was allowed to cool slightly and then poured into an appropriate container.
   B. Preparation of Films from Formulation 4

Using normal spin-coating and UV-curing techniques, the formulation can be coated onto various types of wafers (silicon, quartz, glass, etc.). A CEE 100CB Spinner/Hotplate was used to apply Formulation 4 to wafers. The spin speed was 1,000-5,000 rpm, the acceleration was 4,500 rpm/sec, and the spin time was 60 seconds. The films were then baked for 6 sec at 112° C.

A Canon PLA-501F Parallel Tight Mask Aligner with xenon lamp was used to cure the films. The output was 2.7 mJ-sec/cm² at 365 nm, the time was 9 minutes, and the total exposure dose was 1.5 J/cm².

Representative film processing data for these materials are in Table 7.

TABLE 7

| | Spin | Ramp | Spin | | Exposure | |
|---|---|---|---|---|---|---|
| | Speed | Rate | Time | | Dose | Thickness |
| Wafer # | (rpm) | (rpm/sec) | (sec) | Bake | (J/cm²) | (μm) |
| 1 | 1,000 | 4,500 | 60 | 6 sec | 1.5 | 150 |
| | | | | at 112° C. | | |
| 2 | 2,000 | 4,500 | 60 | 6 sec | 1.5 | 90 |
| | | | | at 112° C. | | |
| 3 | 3,000 | 4,500 | 60 | 6 sec | 1.5 | 50 |
| | | | | at 112° C. | | |
| 4 | 4,000 | 4,500 | 60 | 6 sec | 1.5 | 40 |
| | | | | at 112° C. | | |
| 5 | 5,000 | 4,500 | 60 | 6 sec | 1.5 | 30 |
| | | | | at 112° C. | | |

The data below were obtained through the analysis of the above films by using a prism coupler (Metricon 2010).

TABLE 8

| | Refractive | Refractive | Refractive |
|---|---|---|---|
| | Index | Index | Index |
| Wafer # | at 401 nm | at 633 nm | at 780 nm |
| 1 | 1.6372 | 1.5974 | 1.5897 |
| 2 | 1.6404 | 1.5977 | 1.5919 |
| 3 | 1.6390 | 1.5977 | 1.5903 |
| 4 | 1.6407 | 1.5985 | 1.5899 |
| 5 | 1.6395 | 1.5963 | 1.5903 |

The refractive index (n) and extinction coefficient (k) data (see FIG. 11) were obtained using a variable angle spectroscopic ellipsometer (VASE, H-VASE, J.A. Woollam Company).

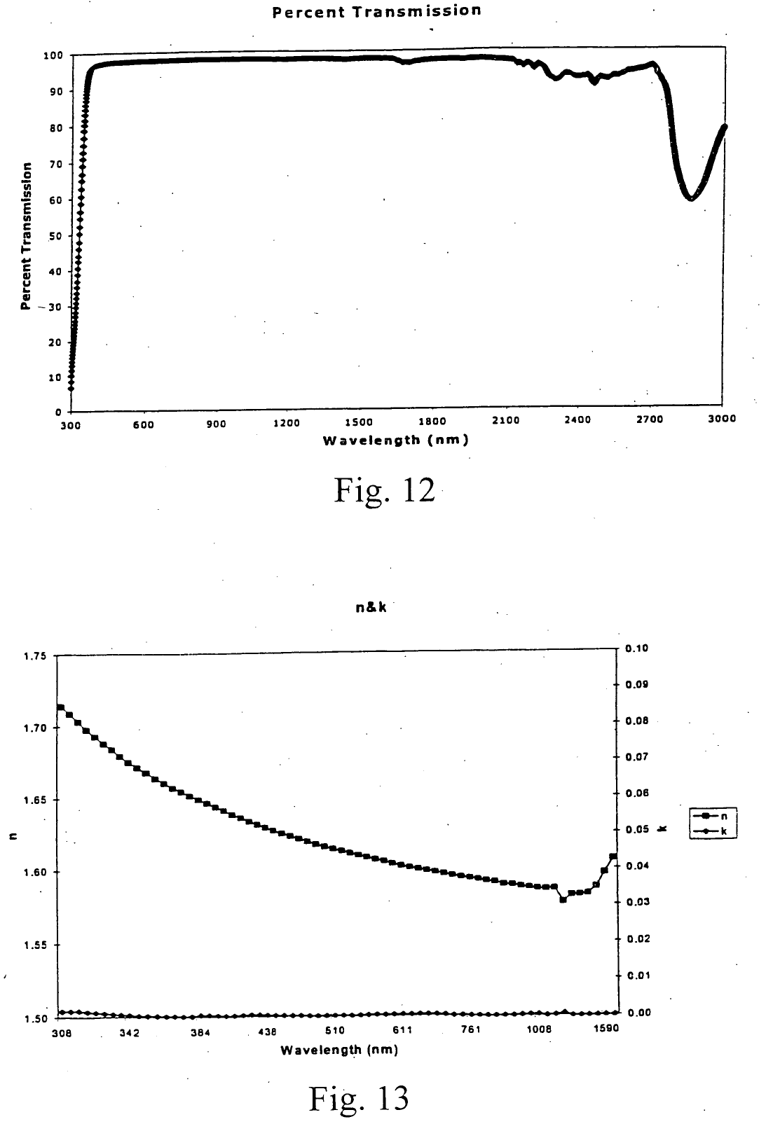

The transmission data of the films, shown in the graph of FIG. 12 and expressed as a percentage, were obtained using a Varian Cary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 5

### A Curable High Refractive Index Resin Prepared with Aromatic Epoxides, Aromatic Vinyl Ethers and Aromatic Epoxy Diluents

### A. Preparation of Formulation 5

The following procedure was used to prepare a curable high refractive index coating:
1. An oil bath was preheated to 80° C. (oil temperature).
2. Approximately 44.10 grams of Dow D.E.R. 332 and 5.00 grams ERISYS GE-10 (CVC Chemical Specialties) were added to a 250-mL round-bottom flask.
3. The (Task and its contents were heated to about 60-70° C. while being stirred with a stir bar or mechanical stirrer.
4. Once the desired temperature was reached, 44.03 grams of Dow D.E.R. 560 were slowly added to the stirring Dow D.E.R. 332.
5. The contents of the flask were stirred for 1.5 hours until both compounds were mixed.
6. Next, 5.00 grams of Morflex Vectomer 4010 were added dropwise.
7. Dow UVI-6976 (The Dow Chemical Company) was added in an amount of 2% by weight, based upon the combined weight of the ingredients already added taken as 100% by weight.
8. The mixture was stirred for 3 hours.
9. The mixture was allowed to cool slightly and then poured into an appropriate container.
   B. Preparation of Films from Formulation 5

Using normal spin-coating and UV-curing techniques, the formulation can be coated onto various types of wafers (silicon, quartz, glass, etc.). A CEE 100CB Spinner/Hotplate was used to apply Formulation 5 to wafers. The spin speed was 1,000-5,000 rpm, the acceleration was 4,500 rpm/see, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2.0 J/cm².

Representative film processing data for these materials are shown in Table 9.

TABLE 9

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.0 | 220 |
| 2 | 2,000 | 4,500 | 60 | 2.0 | 120 |
| 3 | 3,000 | 4,500 | 60 | 2.0 | 90 |
| 4 | 4,000 | 4,500 | 60 | 2.0 | 50 |
| 5 | 5,000 | 4,500 | 60 | 2.0 | 40 |

The data of Table 10 were obtained through the analysis of the above films by using a prism coupler (Metricon 2010).

TABLE 10

| | Refractive | Refractive | Refractive |
|---|---|---|---|
| | Index | Index | Index |
| Wafer # | at 401 nm | at 633 nm | at 780 nm |
| 1 | 1.6388 | 1.5976 | 1.5906 |
| 2 | 1.6390 | 1.5979 | 1.5906 |
| 3 | 1.6390 | 1.5979 | 1.5910 |
| 4 | 1.6391 | 1.5981 | 1.5906 |
| 5 | 1.6390 | 1.5979 | 1.5910 |

The refractive index (n) and extinction coefficient (k) data (see FIG. 13) were obtained using a variable angle spectroscopic ellipsometer (VASE, H-VASE, J.A. Woollam Company).

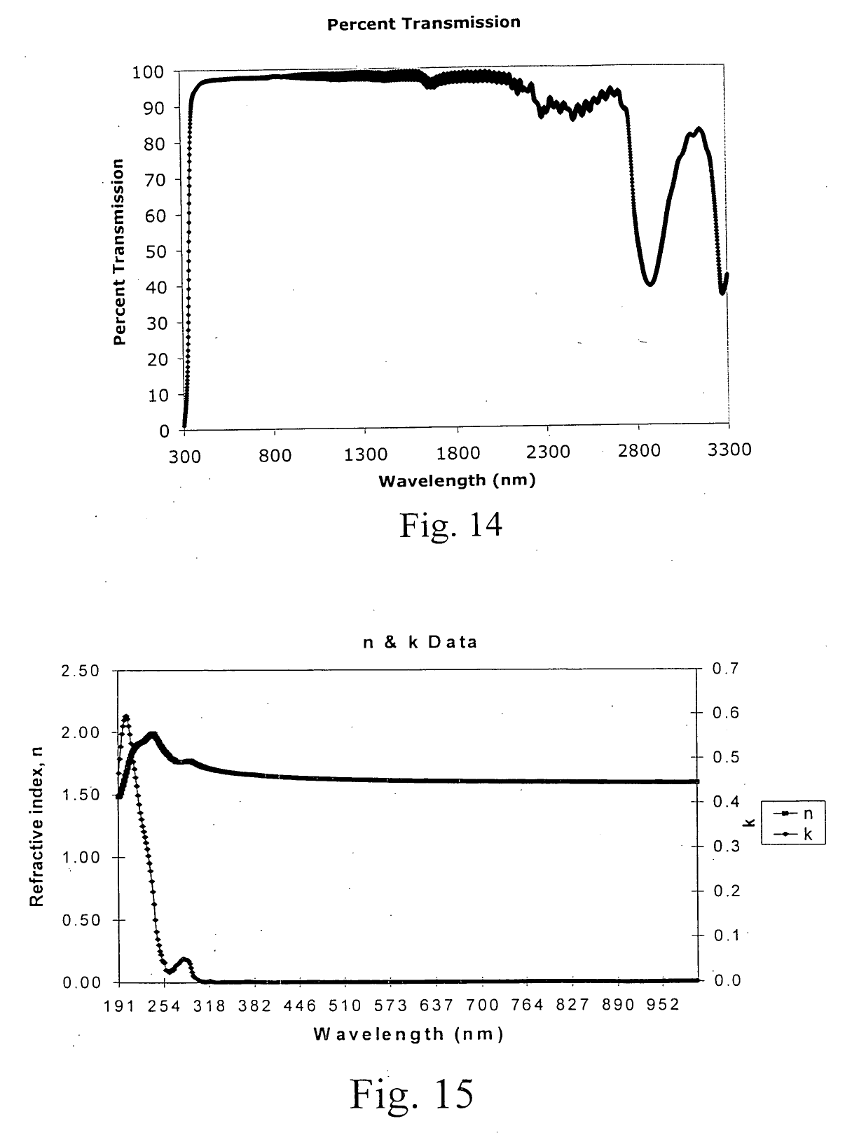

The transmission data of the films, shown in the graph of FIG. 14 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 6

### A Curable High Refractive Index Resin Prepared with Aromatic Epoxides and a Brominated Aromatic Epoxy Diluent

### A. Preparation of Formulation 6

The following procedure was used to prepare a curable high refractive index coating:
1. An oil bath was preheated to 80° C. (oil temperature).
2. Approximately 44.0 grams of Dow D.E.R. 332 were added to a 250-mL round-bottom flask.
3. The flask and its contents were heated to about 60-70° C. while being stirred with a stir bar or mechanical stirrer.
4. Once the desired temperature was reached, 44.0 grams of Dow D.E.R. 560 were slowly added to the stirring Dow D.E.R. 332.
5. The contents of the flask were stirred for 2 hours until both compounds were mixed.
6. Next, 10.0 grams of Nagase ChemTex DENACOL EX-147 were added dropwise.
7. Dow UVI-6976 (The Dow Chemical Company) was added in the amount of 2% by weight, based upon the combined weight of the ingredients already added taken as 100% by weight.
8. The mixture was stirred for 3 hours.
9. The mixture was allowed to cool slightly and then poured into an appropriate container.
   B. Preparation of Films from Formulation 6

Using normal spin-coating and UV-curing techniques, the formulation can be coated onto various types of wafers (silicon, quartz, glass, etc). A CEE 100CB Spinner/Hotplate was used to apply Formulation 6 to wafers. The Spin speed was 1,000-5,000 rpm, the acceleration was 4,500 rpm/sec, and the spin time was 360 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2.0 J/cm².

Representative film processing data for these materials are shown in Table 11.

TABLE 11

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 360 | 2.0 | 310 |
| 2 | 2,000 | 4,500 | 360 | 2.0 | 230 |
| 3 | 3,000 | 4,500 | 360 | 2.0 | 190 |
| 4 | 4,000 | 4,500 | 360 | 2.0 | 170 |
| 5 | 5,000 | 4,500 | 360 | 2.0 | 150 |

The data of Table 12 were obtained through the analysis of the above films by using a prism coupler (Metricon 2010).

TABLE 12

| | Refractive | Refractive | Refractive |
|---|---|---|---|
| | Index | Index | Index |
| Wafer # | at 401 nm | at 633 nm | at 780 nm |
| 1 | 1.6469 | 1.6049 | 1.5973 |
| 2 | 1.6469 | 1.6053 | 1.5974 |
| 3 | 1.6467 | 1.6051 | 1.5974 |
| 4 | 1.6467 | 1.6055 | 1.5973 |
| 5 | 1.6467 | 1.6053 | 1.5974 |

The refractive index (n) and extinction coefficient (k) data (see FIG. 15) were obtained using a variable angle spectroscopic ellipsometer (VASE, M2000 VASE, J.A. Woollam Company).

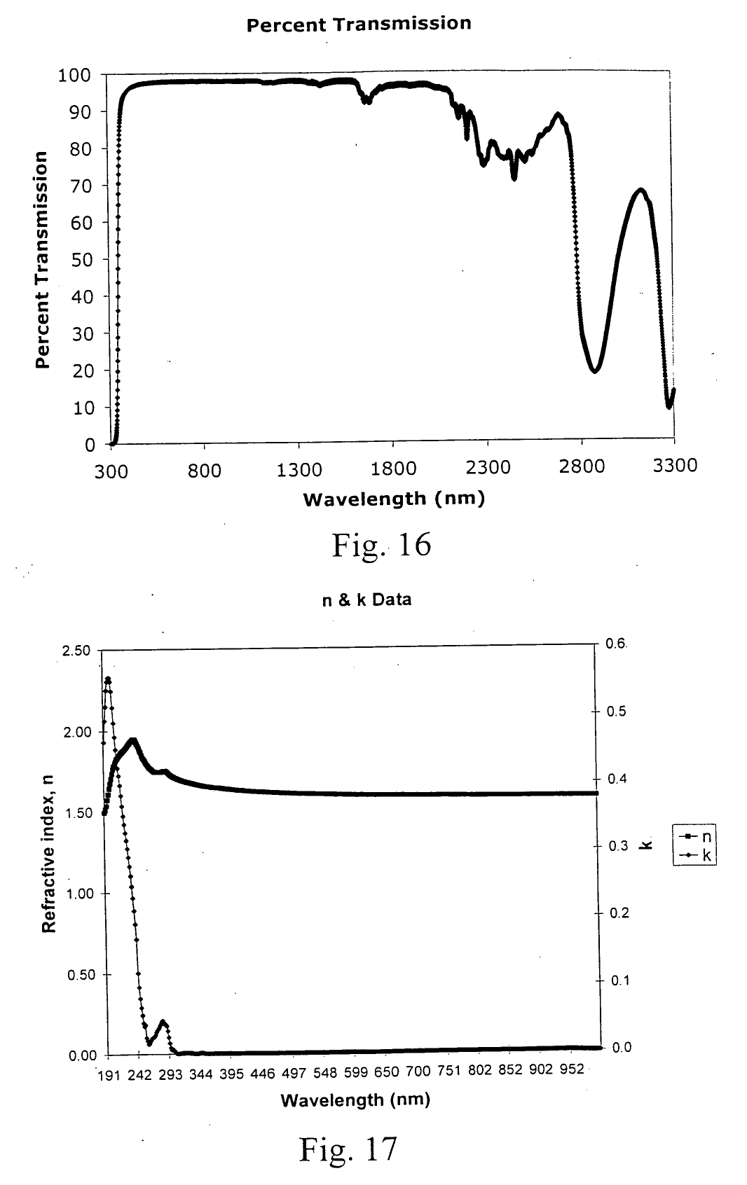

The transmission data of the films, shown in the graph of FIG. 16 and expressed as a percentage, were obtained using a Varian Cary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 7

### A Curable High Refractive Index Resin Prepared with Aromatic Epoxides, an Aromatic Vinyl Ether and an Aromatic Oxetane Diluent

### A. Preparation of Formulation 7

The following procedure was used to prepare a curable high refractive index coating:
1. An oil bath was preheated to 80° C. (oil temperature).
2. Approximately 44.03 grams of Dow D.E.R. 332 were added to a 250-mL round-bottom flask.
3. The flask and its contents were heated to about 60-70° C. while being stirred with a stir bar or mechanical stirrer.
4. Once the desired temperature was reached, 44.06 grams of Dow D.E.R. 560 were slowly added to the stirring Dow D.E.R. 332.
5. The contents of the flask were stirred for 2 hours until both compounds were mixed.
6. Next, 10.00 grams Toagosei Co., Ltd. OXT-121 were added dropwise.
7. Dow UVI-6976 (The Dow Chemical Company) was added in the amount of 2% by weight, based upon the combined weight of the ingredients already added taken as 100% by weight.
8. The mixture was stirred for 3 hours.
9. The mixture was allowed to cool slightly and then poured into an appropriate container.
   B. Preparation of Films from Formulation 7

Using normal spin-coating and UV-curing techniques, the formulation can be coated onto various types of wafers (silicon, quartz, glass, etc.). A CEE 100CB Spinner/Hotplate was used to apply Formulation 7 to wafers. Spin speed was 1,000-5,000 rpm, the acceleration was 4,500 rpm/sec, and the spin time was 360 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2.0 J/cm².

Representative film processing data for these materials are shown in Table 13.

TABLE 13

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 360 | 2.0 | 230 |
| 2 | 2,000 | 4,500 | 360 | 2.0 | 100 |
| 3 | 3,000 | 4,500 | 360 | 2.0 | 60 |
| 4 | 4,000 | 4,500 | 360 | 2.0 | 40 |
| 5 | 5,000 | 4,500 | 360 | 2.0 | 30 |

The data of Table 14 were obtained through the analysis of the above films by using a prism coupler (Metricon 2010).

TABLE 14

| | Refractive Index | Refractive Index | Refractive Index |
|---|---|---|---|
| Wafer # | at 401 nm | at 633 nm | at 780 nm |
| 1 | 1.6337 | 1.5944 | 1.5869 |
| 2 | 1.6337 | 1.5946 | 1.5873 |
| 3 | 1.6388 | 1.5946 | 1.5871 |
| 4 | 1.6333 | 1.5946 | 1.5871 |
| 5 | 1.6337 | 1.5945 | 1.5851 |

The refractive index (n) and extinction coefficient (k) data (sec FIG. 17) were obtained using a variable angle spectroscopic ellipsometer (VASE, M2000 VASE, J.A. Woollam Company).

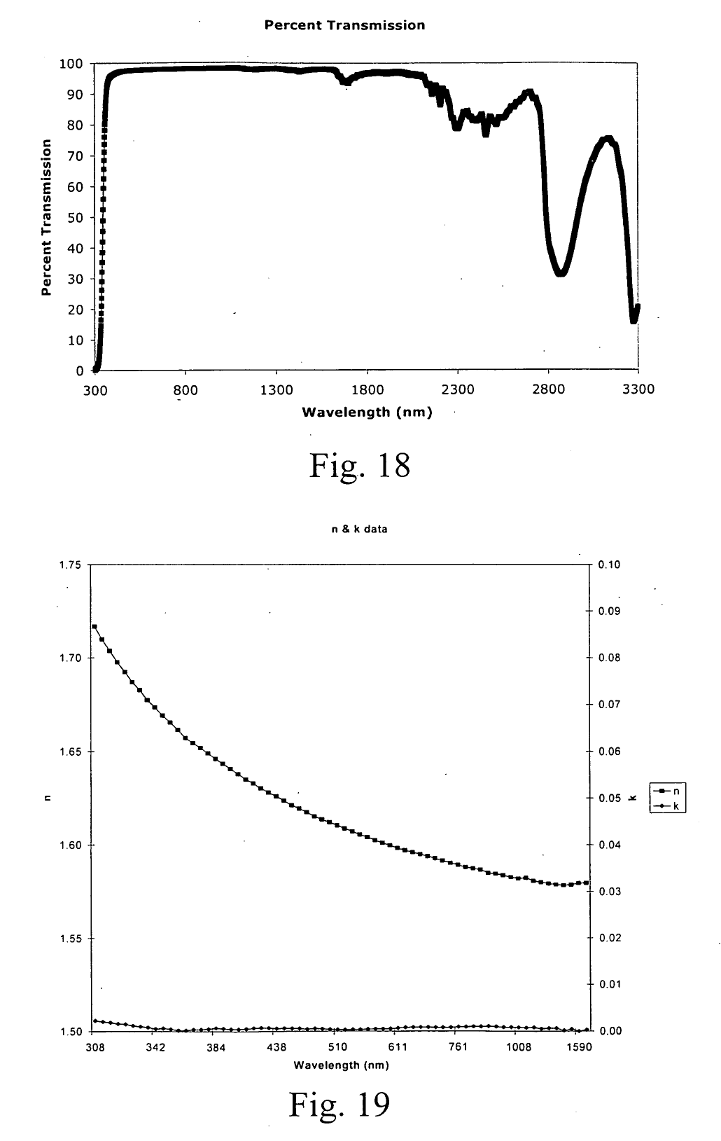

The transmission data of the films, shown in the graph of FIG. 18 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min 0.00, and Y max 100.00. The baseline parameter was zero/baseline.

### Example 8

### A Curable High Refractive Index Resin Prepared with Epoxy Novolac Resin

### A. Preparation of Formulation 8

The following procedure was used to prepare a curable high refractive index coating:
1. An oil bath was preheated to 80° C. (oil temperature).
2. Approximately 117.93 grams of Dow D.E.N. 431 were added to a 250-mL round-bottom flask.
3. The flask and its contents were heated to about 60-70° C. while being stirred with a stir bar or mechanical stirrer.
4. Dow UVI-6976 (The Dow Chemical Company) was added in an amount of 2% by weight, based upon the combined weight of the ingredients already added taken as 100% by weight.
5. The mixture was stirred for 3 hours.
6. The mixture was allowed to cool slightly and then poured into an appropriate container.
   B. Preparation of Films from Formulation 8

Using normal spin-coating and UV-curing techniques, the formulation can be coated onto various types of wafers (silicon, quartz, glass, etc.). A CEE 100CB Spinner/Hotplate was used to apply Formulation 8 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure doses was 2.0 J/cm².

Representative film processing data for these materials are shown in Table 15.

TABLE 15

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.0 | 300 |
| 2 | 2,000 | 4,500 | 60 | 2.0 | 140 |
| 3 | 3,000 | 4,500 | 60 | 2.0 | 70 |
| 4 | 4,000 | 4,500 | 60 | 2.0 | 60 |
| 5 | 5,000 | 4,500 | 60 | 2.0 | 50 |

The data shown in Table 16 were obtained through the analysis of the above films by using a prism coupler (Metricon 2010).

TABLE 16

| | Refractive Index | Refractive Index | Refractive Index |
|---|---|---|---|
| Wafer # | at 401 nm | at 633 nm | at 780 nm |
| 1 | 1.6421 | 1.5997 | 1.5922 |
| 2 | 1.6421 | 1.5997 | 1.5920 |
| 3 | 1.6418 | 1.6000 | 1.5922 |
| 4 | 1.6420 | 1.5999 | 1.5922 |
| 5 | 1.6425 | 1.5999 | 1.5924 |

The refractive index (n) and extinction coefficient (k) data (see FIG. 19) were obtained using a variable angle spectroscopic ellipsometer (VASE. H-VASE, J.A. Woollam Company).

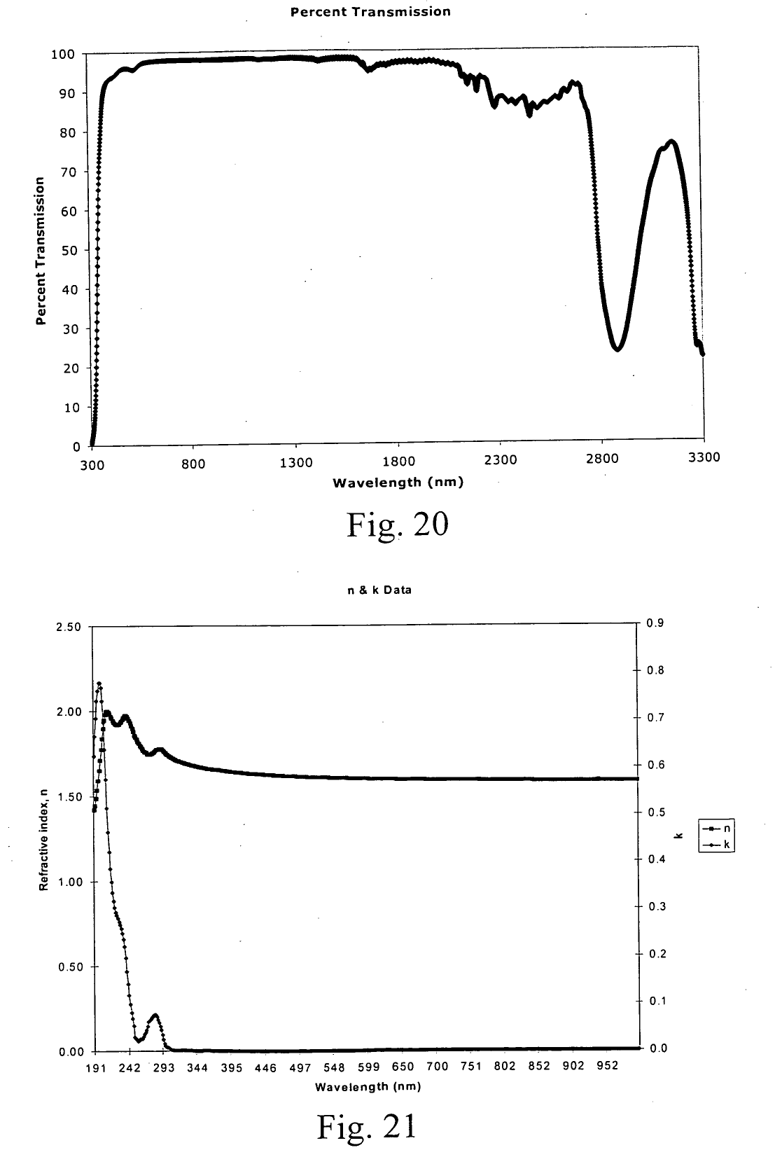

The transmission data of the films, shown in the graph of FIG. 20 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 9

### A Curable High Refractive Index Resin Prepared with Epoxy Novolac Resin and an Aromatic Epoxy Diluent

### A. Preparation of Formulation 9

The following procedure was used to prepare a curable high refractive index coating:
1. First, 89.03 grams Dow D.E.N. 431, 9.03 grams ERISYS GE-10 (CVC Chemical Specialties), and 1.99 grams Dow UVI-6976 were measured into a 125-mL, brown Nalgene bottle.
2. The components were combined on a mixing wheel for 72 hours at 50 rpm.
   B. Preparation of Films from Formulation 9

Using normal spin-coating and UV-curing techniques, the formulation can be coated onto various types of wafers (silicon, quartz, glass, etc.). A CEE 100CB Spinner/Hotplate was used to apply Formulation 9 to wafers. The spin speed was 1,000-5,000 rpm, the acceleration was 4.500 rpm/sec, and the spin time was 360 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2.0 J/cm².

Representative film processing data for these materials are shown in Table 17.

TABLE 17

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 360 | 2.0 | 55.48 |
| 2 | 2,000 | 4,500 | 360 | 2.0 | 29.02 |
| 3 | 3,000 | 4,500 | 360 | 2.0 | 19.24 |
| 4 | 4,000 | 4,500 | 360 | 2.0 | 14.48 |
| 5 | 5,000 | 4,500 | 360 | 2.0 | 11.55 |

The data of Table 18 were obtained through the analysis of the above films by using a prism coupler (Metricon 2010).

TABLE 18

| | Refractive Index | Refractive Index | Refractive Index |
|---|---|---|---|
| Wafer # | at 401 nm | at 633 nm | at 780 nm |
| 1 | 1.6391 | 1.5985 | 1.5901 |
| 2 | 1.6390 | 1.5976 | 1.5897 |
| 3 | 1.6397 | 1.5983 | 1.5899 |
| 4 | 1.6397 | 1.5981 | 1.5899 |
| 5 | 1.6398 | 1.5977 | 1.5903 |

The refractive index (n) and extinction coefficient (k) data (sec FIG. 21) were obtained using a variable angle spectroscopic ellipsometer (VASE. M2000 VASE, J.A. Woollam Company).

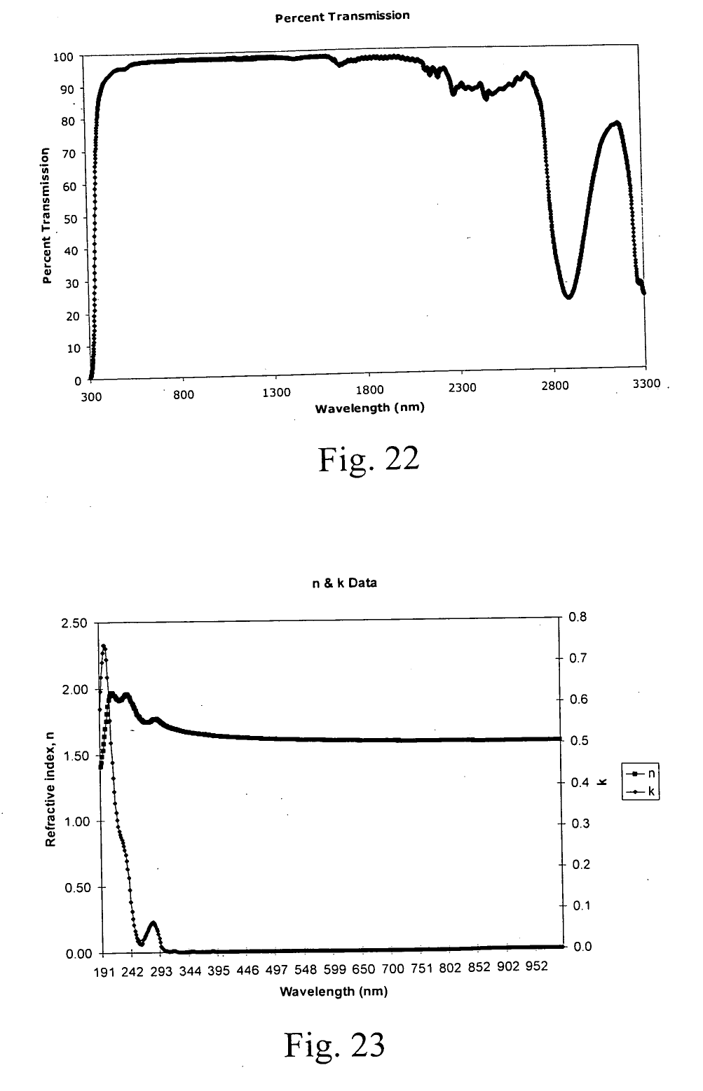

The transmission data of the films, shown in the graph of FIG. 22 and expressed as a percentage, were obtained using a Varian Gary 500 Scan UV-Vis-NIR Dual Ream Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 10

### A Curable High Refractive Index Resin Prepared with Epoxy Novolac Resin and an Aromatic Vinyl Ether Diluent

### A. Preparation of Formulation 10

The following procedure was used to prepare a curable high refractive index coating:
1. First, 60.86 grams Dow D.E.N. 431, 6.16 grams VECTOMER 4010 (Morflex), and 1.37 grams Dow UVI-6976 were measured into a 125-mL, brown Nalgene bottle.
2. The components were combined on a mixing wheel for 72 hours at 50 rpm.
   B. Preparation of Films from Formulation 10

Using normal spin-coating and UV-curing techniques, the formulation can be coated onto various types of wafers (silicon, quartz, glass, etc.). A CEE 100CB Spinner/Hotplate was used to apply Formulation 10 to wafers. Spin speed was 1,000-5,000 rpm, the acceleration was 4,500 rpm/sec, and the spin time was 360 seconds.

A Canon PLA-501F Parallel Light Mask Aligner with xenon lamp was used to cure the films. The output was 2.7 mJ-sec/cm² at 365 nm, the time was 7.5 minutes, and the total exposure dose was 1.2 J/cm².

Representative film processing data for these materials are shown Table 19.

TABLE 19

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 360 | 1.2 | 82.85 |
| 2 | 2,000 | 4,500 | 360 | 1.2 | 38.16 |
| 3 | 3,000 | 4,500 | 360 | 1.2 | 25.02 |
| 4 | 4,000 | 4,500 | 360 | 1.2 | 18.49 |
| 5 | 5,000 | 4,500 | 360 | 1.2 | 14.22 |

The data from Table 20 were obtained through the analysis of the above films by using a prism coupler (Metricon 2010).

TABLE 20

| | Refractive Index | Refractive Index | Refractive Index |
|---|---|---|---|
| Wafer # | at 401 nm | at 633 nm | at 780 nm |
| 1 | 1.6368 | 1.5953 | 1.5878 |
| 2 | 1.6372 | 1.5956 | 1.5878 |
| 3 | 1.6360 | 1.5958 | 1.5880 |
| 4 | 1.6367 | 1.5953 | 1.5882 |
| 5 | 1.6370 | 1.5949 | 1.5878 |

The refractive index (n) and extinction coefficient (k) data (see FIG. 23) were obtained using a variable angle spectroscopic ellipsometer (VASE, M2000 VASE, J.A. Woollam Company).

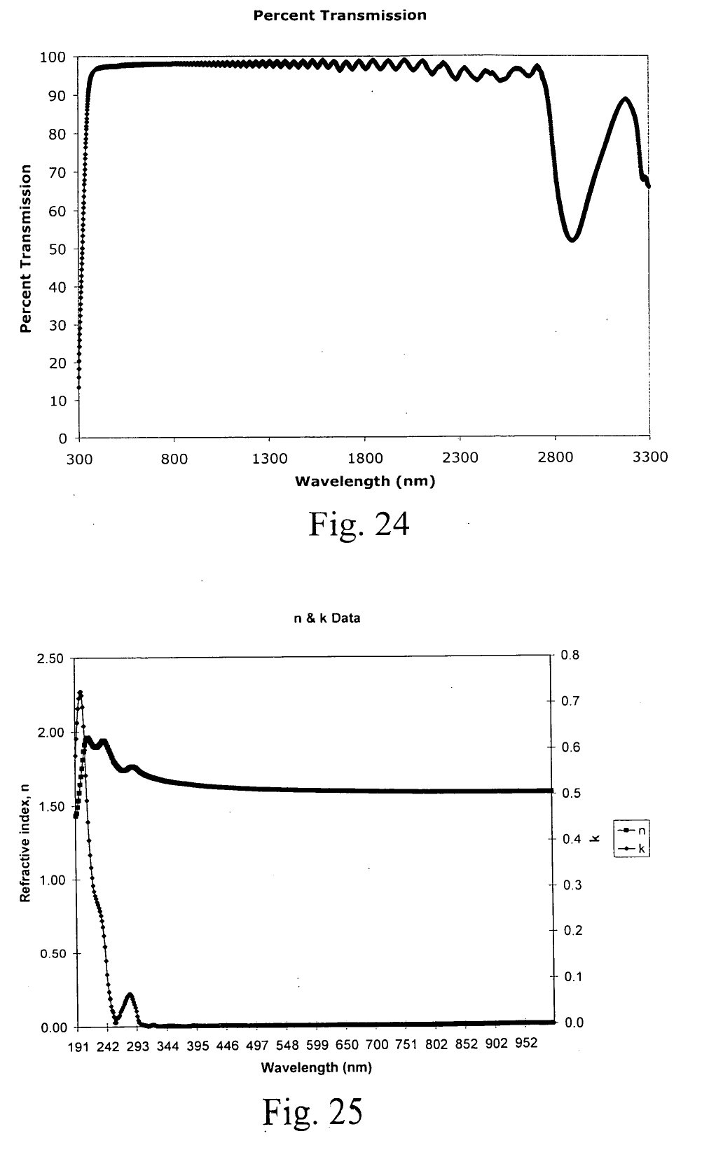

The transmission data of the films, shown in the graph of FIG. 24 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 11

### A Curable High Refractive Index Resin Prepared with Epoxy Novolac Resin and an Aromatic Oxetane Diluent

### A. Preparation of Formulation 11

The following procedure was used to prepare a curable high refractive index coating:
1. An oil bath was preheated to 80° C. (oil temperature).
2. Approximately 88.74 grams of Dow D.E.N. 431 and 8.96 grams OXT-121 (Toagosei Co., Ltd.) were added to a 250-mL round-bottom flask.
3. The flask and its contents were heated to about 60-70° C. while being stirred with a stir bar or mechanical stirrer.
4. The mixture was stirred for 40 minutes.
5. Dow UVI-0976 (The Dow Chemical Company) was added in an amount of 2% by weight, based upon the combined weight of the ingredients already added taken as 100% by weight.
6. The mixture was stirred for 50 minutes.
7. The mixture was allowed to cool slightly and then poured into an appropriate container.
   B. Preparation of Films from Formulation 11

Using normal spin-coating and UV-curing techniques, the formulation can be coated onto various types of wafers (silicon, quartz, glass, etc.). A CEE 100CB Spinner/Hotplate was used to apply Formulation 11 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 7.5 minutes, and the total exposure dose was 1.2 J/cm².

Representative film processing data for these materials are shown in Table 21.

TABLE 21

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 1.2 | 230.0 |
| 2 | 2,000 | 4,500 | 60 | 1.2 | 125.0 |
| 3 | 3,000 | 4,500 | 60 | 1.2 | 90.0 |
| 4 | 4,000 | 4,500 | 60 | 1.2 | 62.0 |
| 5 | 5,000 | 4,500 | 60 | 1.2 | 50.0 |

The data of Table 22 were obtained through the analysis of the above films by using a prism coupler (Metricon 2010).

TABLE 22

| | Refractive Index | Refractive Index | Refractive Index |
|---|---|---|---|
| Wafer # | at 401 nm | at 633 nm | at 780 nm |
| 1 | 1.6338 | 1.5934 | 1.5859 |
| 2 | 1.6337 | 1.5937 | 1.5857 |
| 3 | 1.6338 | 1.5937 | 1.5857 |
| 4 | 1.6337 | 1.5941 | 1.5859 |
| 5 | 1.6340 | 1.5937 | 1.5859 |

The refractive index (n) and extinction coefficient (k) data (see FIG. 25) were obtained using a variable angle spectroscopic ellipsometer (VASE, M2000 VASE, J.A. Woollam Company).

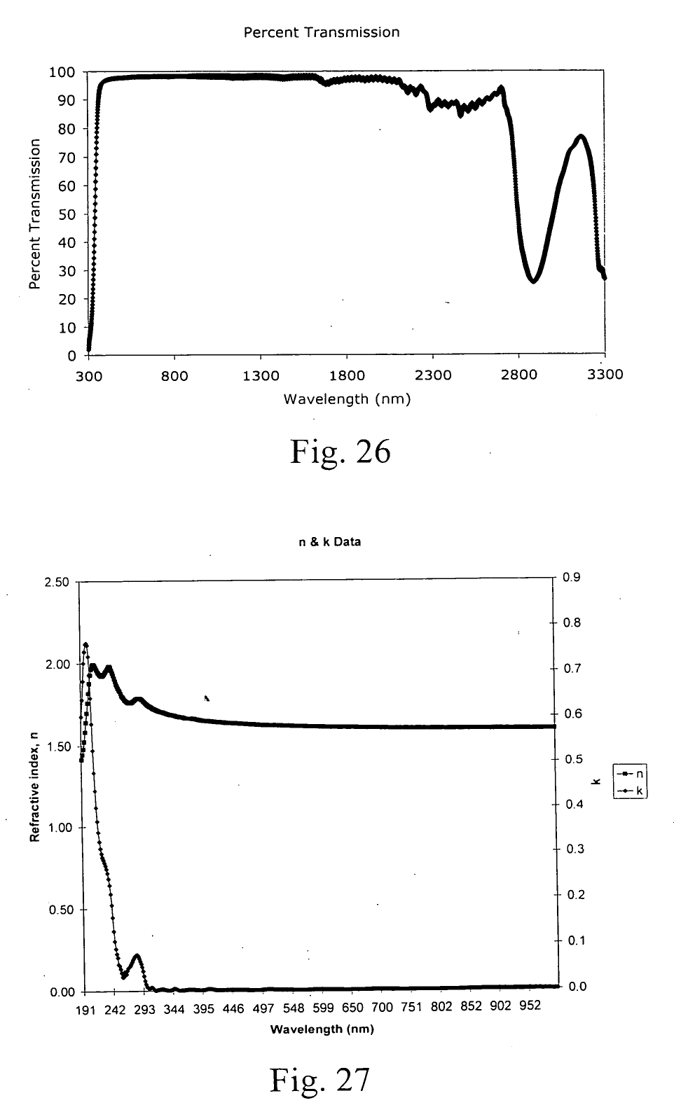

The transmission data of the films, shown in the graph of FIG. 26 and expressed as a percentage, were obtained using a Varian Gary 500 Scan UV-Vis-NIR Dual Beam Spectrophotometer. The mode used was nanometers, with a range of 300-3300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 12

### A Curable High Refractive Index Resin Prepared with Epoxy Novolac Resin and a Brominated Aromatic Epoxy Diluent

### A. Preparation of Formulation 12

The following procedure was used to prepare a curable high refractive index coating:
1. An oil bath was preheated to 80° C. (oil temperature).
2. Approximately 89.13 grams of Dow D.E.N. 431 and 9.01 grams DENACOL EX-147 (Nagase ChemTex) were added to a 250-mL round-bottom flask.
3. The flask and its contents were heated to about 60-70° C. while being stirred with a stir bar or mechanical stirrer.
4. The mixture was stirred for 2 hours.
5. Dow UVI-6976 (The Dow Chemical Company) was added in the amount of 2% by weight, based upon the combined weight of the ingredients already added taken as 100% by weight.
6. The mixture was stirred for 3 hours.
7. The mixture was allowed to cool slightly and then poured into an appropriate container.
   B. Preparation of Films from Formulation 12

Using normal spin-coating and UV-curing techniques, the formulation can be coated onto various types of wafers (silicon, quartz, glass, etc.). A CEE 100CB Spinner/Hotplate was used to apply Formulation 12 to wafers. The spin speed was 1,000-5,000 rpm, the acceleration was 4,500 rpm/sec, and the spin time was 360 seconds.

A Canon PLA-501F Parallel Light Mask Aligner with xenon lamp was used to cure the films. The output was 2.7 ml-sec/cm² at 365 nm, and the time was 10 minutes, and the total exposure dose was 1.6 J/cm².

Representative film processing data for these materials are shown in Table 23.

TABLE 23

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 1.6 | 120.0 |
| 2 | 2,000 | 4,500 | 60 | 1.6 | 51.5 |
| 3 | 3,000 | 4,500 | 60 | 1.6 | 32.5 |
| 4 | 4,000 | 4,500 | 60 | 1.6 | 23.4 |
| 5 | 5,000 | 4,500 | 60 | 1.6 | 18.2 |

The data of Table 24 were obtained through the analysis of the above films by using a prism coupler (Metricon 2010).

TABLE 24

| | Refractive Index | Refractive Index | Refractive Index |
|---|---|---|---|
| Wafer # | at 401 nm | at 633 nm | at 780 nm |
| 1 | 1.6450 | 1.6025 | 1.5946 |
| 2 | 1.6450 | 1.6028 | 1.5948 |
| 3 | 1.6450 | 1.6038 | 1.5952 |
| 4 | 1.6448 | 1.6038 | 1.5952 |
| 5 | 1.6443 | 1.6027 | 1.5950 |

The refractive index (n) and extinction coefficient (k) data (see FIG. 27) were obtained using a variable angle spectroscopic ellipsometer (VASE, M2000 VASE. J.A. Woollam Company).

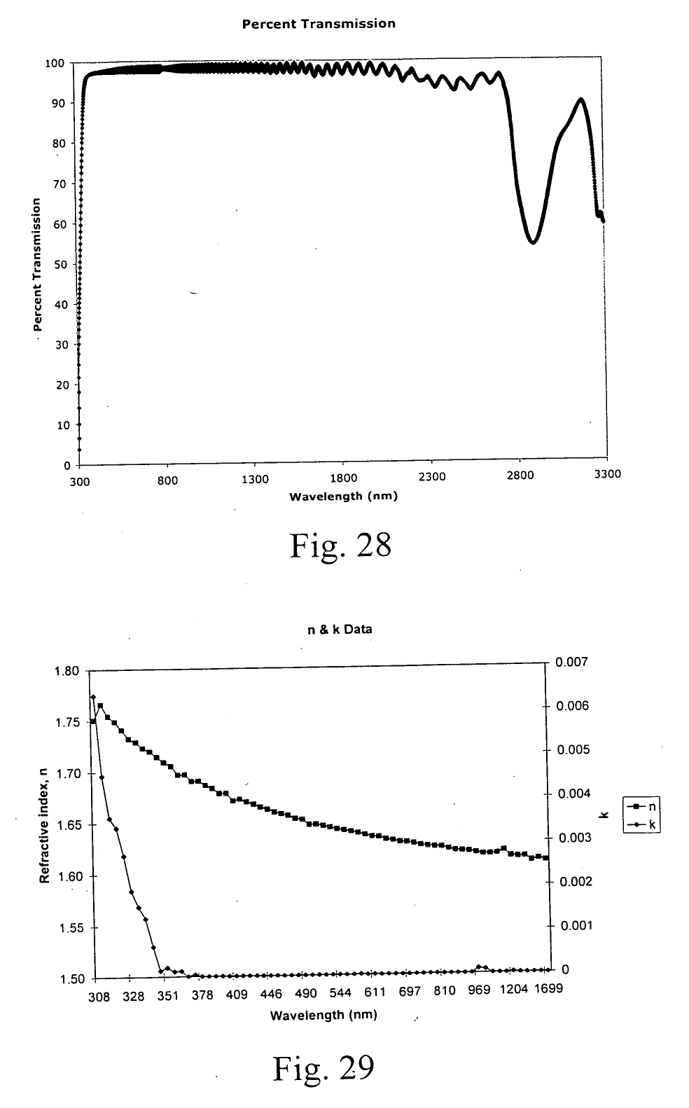

The transmission data of the films, shown in the graph of FIG. 28 and expressed as a percentage, were obtained using a Varian Cary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min=0.00, and Y max= 100.00. The baseline parameter was zero/baseline.

### Example 13

### A Curable High Refractive Index Resin

### Prepared with a Brominated Epoxy Resin

### A. Preparation of Formulation 13

The following procedure was used to prepare a curable high refractive index coating:
1. First, 94.99 grams of DENACOL EX-147 (Nagase ChemTex) and 4.99 grams of Dow UVI-6976 were measured into a 125-mL, brown Nalgene bottle.
2. The components were combined on a mixing wheel for 24 hours at 50 rpm.
   B. Preparation of Films from Formulation 10

Using normal spin-coating and UV-curing techniques, the formulation can be coated onto various types of wafers (silicon, quartz, glass, etc.). A CEE 100CB Spinner/Hotplate was used to apply Formulation 13 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure doses was 2.0 J/cm².

Representative film processing data for these materials are shown in Table 25.

TABLE 25

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 1.2 | 8.3144 |
| 2 | 2,000 | 4,500 | 60 | 1.2 | 4.5903 |
| 3 | 3,000 | 4,500 | 60 | 1.2 | 3.0305 |
| 4 | 4,000 | 4,500 | 60 | 1.2 | 2.2445 |
| 5 | 5,000 | 4,500 | 60 | 1.2 | N/A |

The data of Table 26 were obtained through the analysis of the above films by using a prism coupler (Metricon 2010).

TABLE 26

| | Refractive Index | Refractive Index | Refractive Index |
|---|---|---|---|
| Wafer # | at 401 nm | at 633 nm | at 780 nm |
| 1 | 1.6625 | 1.6185 | 1.6097 |
| 2 | 1.6645 | 1.6194 | 1.6107 |
| 3 | 1.6662 | 1.6221 | 1.6133 |
| 4 | 1.6707 | 1.6224 | 1.6144 |
| 5 | N/A | N/A | N/A |

The refractive index (n) and extinction coefficient (k) data (see FIG. 29) were obtained using a variable angle spectroscopic ellipsometer (VASE, FI-VASE, J.A. Woollam Company).

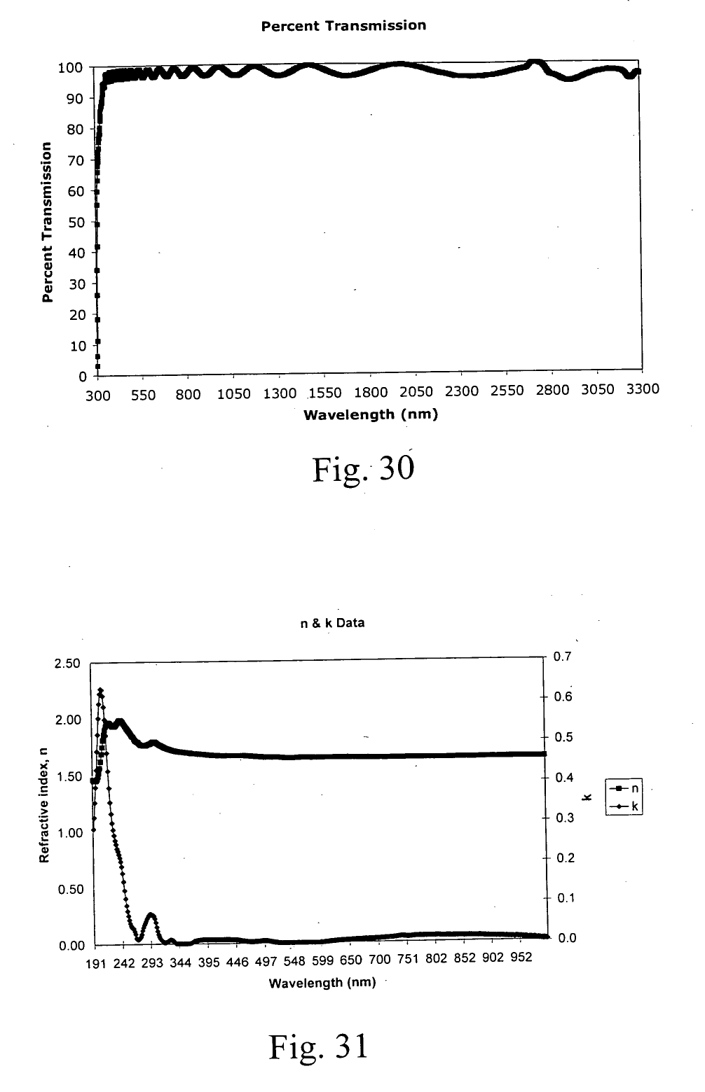

The transmission data of the films, shown in the graph of FIG. 30 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 14

### A Curable High Refractive Index Resin Prepared with a Brominated Epoxy Resin and an Aromatic Vinyl Ether Diluent

### A. Preparation of Formulation 14

The following procedure was used to prepare a curable high refractive index coating:
1. First, 89.07 grams of DENACOL EX-147 (Nagase ChemTex), 9.00 grams of VECTOMER 4010 (Morflex), and 2.03 grams Dow UVI-6976 were measured into a 125-mL, brown Nalgene bottle.
2. The components were combined on a mixing wheel for 24 hours at 50 rpm.
   B. Preparation of Films from Formulation 14

Using normal spin-coating and UV-curing techniques, the formulation can be coated onto various types of wafers (silicon, quartz, glass, etc.). A CEE 100CB Spinner/Hotplate was used to apply formulation 14 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 37 minutes, and the total exposure dose was 6.03 J/cm².

Representative film processing data for these materials are shown in Table 27.

TABLE 27

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 6.03 | 8.71 |
| 2 | 2,000 | 4,500 | 60 | 6.03 | 4.05 |
| 3 | 3,000 | 4,500 | 60 | 6.03 | 2.92 |
| 4 | 4,000 | 4,500 | 60 | 6.03 | 2.05 |
| 5 | 5,000 | 4,500 | 60 | 6.03 | 1.65 |

The data of Table 28 were obtained through the analysis of the above films by using a prism coupler (Metricon 2010).

TABLE 28

| | Refractive Index | Refractive Index | Refractive Index |
|---|---|---|---|
| Wafer # | at 401 nm | at 633 nm | at 780 nm |
| 1 | 1.6568 | 1.6123 | 1.6064 |
| 2 | 1.6566 | 1.6170 | 1.6053 |
| 3 | 1.6573 | 1.6141 | 1.6046 |
| 4 | 1.6582 | 1.6137 | 1.6056 |
| 5 | 1.6586 | 1.6139 | 1.6062 |

The refractive index (n) and extinction coefficient (k) data (see FIG. 31) were obtained using a variable angle spectroscopic ellipsometer (VASE, M2000 VASE, J.A. Woollam Company).

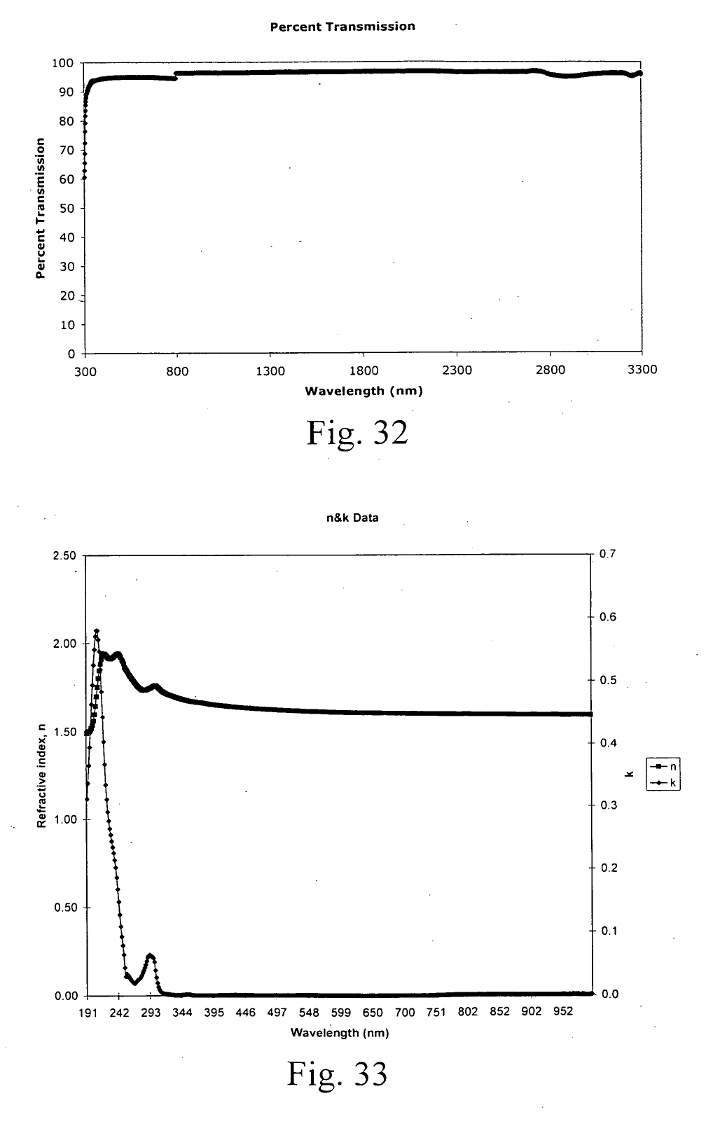

The transmission data of the films, shown in the graph of FIG. 32 and expressed as a percentage, were obtained using a Varian Gary 500 Scan UV-Vis-NIR Dual Beam Spectrophotometer. The mode used was nanometers, with a range of 300-3.300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 15

### A Curable High Refractive Index Resin Prepared with a Brominated Epoxy Resin and an Aromatic Oxetane Diluent

### A. Preparation of Formulation 15

The following procedure was used to prepare a curable high refractive index coating:
1. First, 89.01 grams DENACOL EX-147 (Nagase ChemTex), 9.04 grams OXT-121 (Toagosei Co., Ltd.), and 2.02 grams Dow UVI-6976 were measured into a 125-mL, brown Nalgene bottle.
2. The components were combined on a mixing wheel for 72 hours at 50 rpm.
   B. Preparation of Films from Formulation 15

Using normal spin-coating and UV-curing techniques, the formulation can be coated onto various types of wafers (silicon, quartz, glass, etc.). A CEE 100CB Spinner/Hotplate was used to apply Formulation 15 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2.0 J/cm².

Representative film processing data for these materials are shown in Table 29.

TABLE 29

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.0 | 10.07 |
| 2 | 2,000 | 4,500 | 60 | 2.0 | 4.98 |
| 3 | 3,000 | 4,500 | 60 | 2.0 | 3.37 |
| 4 | 4,000 | 4,500 | 60 | 2.0 | 2.52 |
| 5 | 5,000 | 4,500 | 60 | 2.0 | 1.97 |

The data of Table 30 were obtained through the analysis of the above films by using a prism coupler (Metricon 2010).

TABLE 30

| | Refractive Index | Refractive Index | Refractive Index |
|---|---|---|---|
| Wafer # | at 401 nm | at 633 nm | at 780 nm |
| 1 | 1.6528 | 1.6115 | 1.6028 |
| 2 | 1.6530 | 1.6114 | 1.6033 |
| 3 | 1.6539 | 1.6119 | 1.6033 |
| 4 | 1.6543 | 1.6123 | 1.6038 |
| 5 | 1.6551 | 1.6125 | 1.6050 |

The refractive index (n) and extinction coefficient (k) data of FIG. 33 were obtained using a variable angle spectroscopic ellipsometer (VASE, M12000 VASE, J.A. Woollam Company).

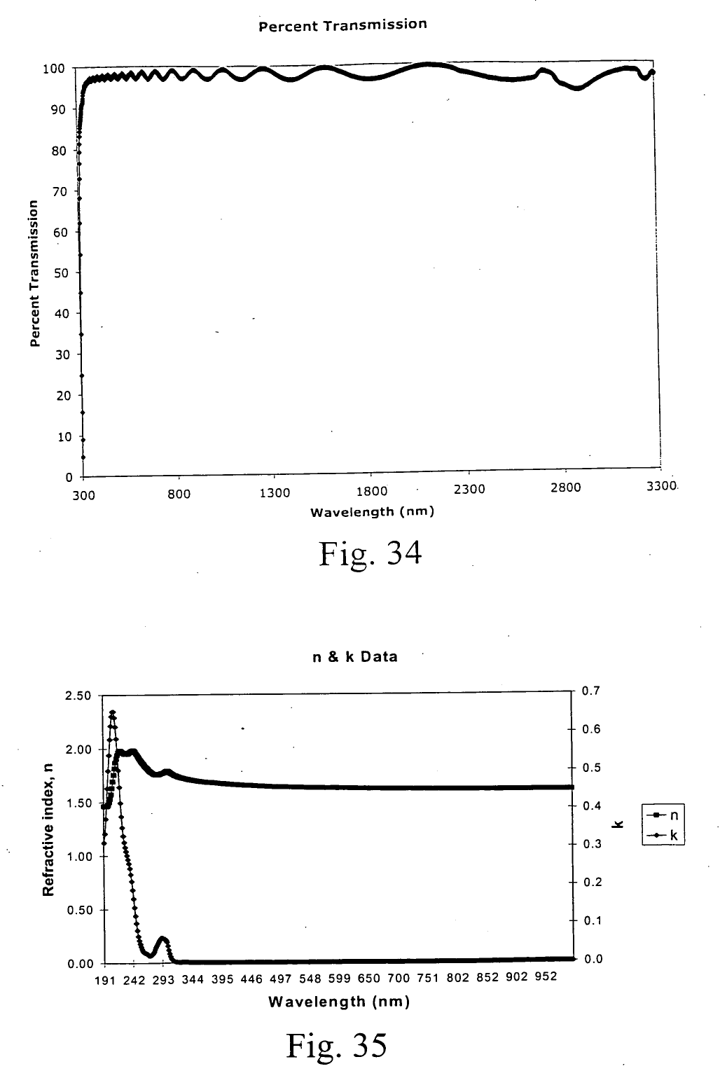

The transmission data of the films, shown in the graph of FIG. 34 and expressed as a percentage, were obtained using a Varian Cary 500 Scan UV-Vis-NIR Dual Beam Spectrophotometer. The mode used was nanometers, with a range of 300-3300 nm. For the scan controls, the average time was 0.1 second, the data interval was 1.0 nm, and the scan rate was 600 nm/min. The Y mode parameters were Y min= 0.00, and Y max=100.00. The baseline parameter was zero/baseline.

### Example 16

### A Curable High Refractive Index Resin Prepared with a Brominated Epoxy Resin and a Brominated Epoxy Novolac

### A. Preparation of Formulation 16

The following procedure was used to prepare a curable high refractive index coating:
1. First, 89.02 grams of DENACOL EX-147 (Nagase ChemTex), 9.03 grams BREN 304 (Nippon Kayaku Company, Ltd.), and 2.01 grams Dow UVI-6976 were measured into a 125-mL, brown Nalgene bottle.
2. The components were combined on a mixing wheel for 72 hours at 50 rpm.
   B. Preparation of Films from Formulation 16

Using normal spin-coating and UV-curing techniques, the formulation can be coated onto various types of wafers (silicon, quartz, glass, etc.). A CEE 100CB Spinner/Hotplate was used to apply Formulation 16 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 14.5 minutes, and the total exposure dose was 2.3 J/cm².

Representative film processing data for these materials are shown in Table 31.

TABLE 31

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.3 | 14.3702 |
| 2 | 2,000 | 4,500 | 60 | 2.3 | 7.0820 |
| 3 | 3,000 | 4,500 | 60 | 2.3 | 4.6592 |
| 4 | 4,000 | 4,500 | 60 | 2.3 | 3.4995 |
| 5 | 5,000 | 4,500 | 60 | 2.3 | 2.4918 |

The data of Table 32 were obtained through the analysis of the above films by using a prism coupler (Metricon 2010).

TABLE 32

| | Refractive Index | Refractive Index | Refractive Index |
|---|---|---|---|
| Wafer # | at 401 nm | at 633 nm | at 780 nm |
| 1 | 1.6693 | 1.6263 | 1.6173 |
| 2 | 1.6719 | 1.6267 | 1.6180 |
| 3 | 1.6729 | 1.6284 | 1.6191 |
| 4 | 1.6739 | 1.6282 | 1.6204 |
| 5 | 1.6730 | 1.6280 | 1.6191 |

The refractive index (n) and extinction coefficient (k) data (see FIG. 35) were obtained using a variable angle spectroscopic ellipsometer (VASE, M2000 VASE, J.A. Woollam Company).

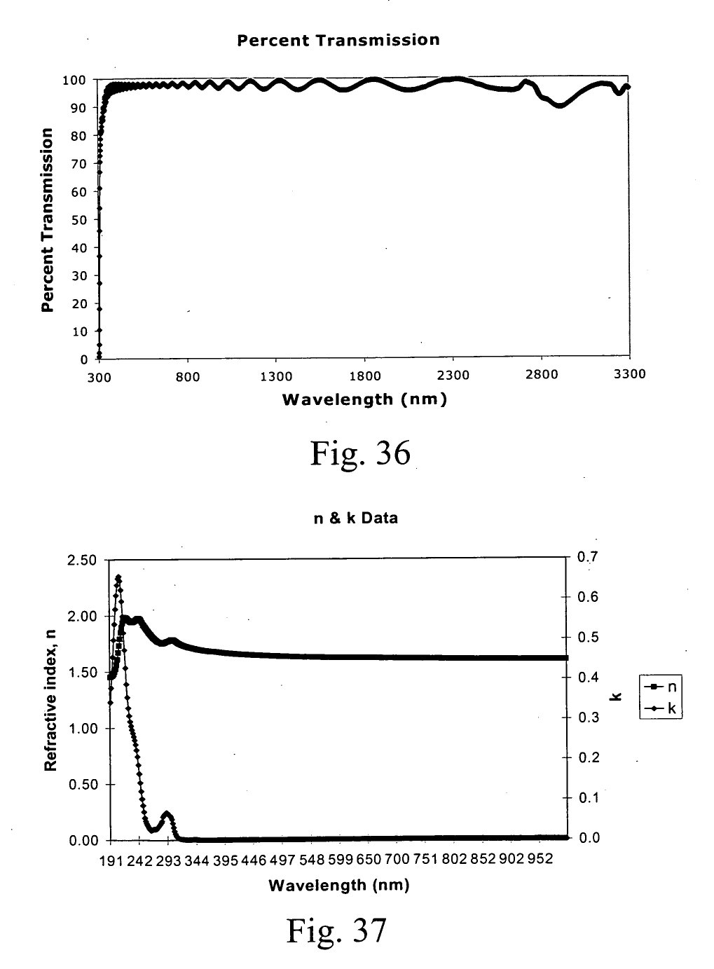

The transmission data of the films, shown in the graph of FIG. 36 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min=0.00, and Y max=100.00, The baseline parameter was zero/baseline.

### Example 17

### A Curable High Refractive Index Resin Prepared with a Brominated Epoxy Resin and an Epoxy Novolac

### A. Preparation of Formulation 17

The following procedure was used to prepare a curable high refractive index coating:
1. First, 89.00 grams of DENACOL EX-147 (Nagase ChemTex), 9.00 grams Dow D.E.N. 431, and 2.02 grams Dow UVI-6976 were measured into a 125-mL, brown Nalgene bottle.
2. The components were combined on a mixing wheel for 72 hours at 50 rpm.
   B. Preparation of Films from Formulation 17

Using normal spin-coating and UV-curing techniques, the formulation can be coated onto various types of wafers (silicon, quartz, glass, etc.). A CEE 100CB Spinner/Hotplate was used to apply Formulation 17 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure dose was 1.9 J/cm².

Representative film processing data for these materials are shown in Table 33.

TABLE 33

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 1.9 | 13.01 |
| 2 | 2,000 | 4,500 | 60 | 1.9 | 6.53 |
| 3 | 3,000 | 4,500 | 60 | 1.9 | 4.36 |
| 4 | 4,000 | 4,500 | 60 | 1.9 | 3.21 |
| 5 | 5,000 | 4,500 | 60 | 1.9 | 2.66 |

The data of Table 34 were obtained through the analysis of the above films by using a prism coupler (Metricon 2010).

TABLE 34

| | Refractive Index | Refractive Index | Refractive Index |
|---|---|---|---|
| Wafer # | at 401 nm | at 633 nm | at 780 nm |
| 1 | 1.6688 | 1.6234 | 1.6150 |
| 2 | 1.6665 | 1.6230 | 1.6380 |
| 3 | 1.6683 | 1.6234 | 1.6165 |
| 4 | 1.6676 | 1.6231 | 1.6146 |
| 5 | 1.6683 | 1.6235 | 1.6148 |

The refractive index (n) and extinction coefficient (k) data (see FIG. 37) were obtained using a variable angle spectroscopic ellipsometer (VASE, M2000 VASE, J.A. Woollam Company).

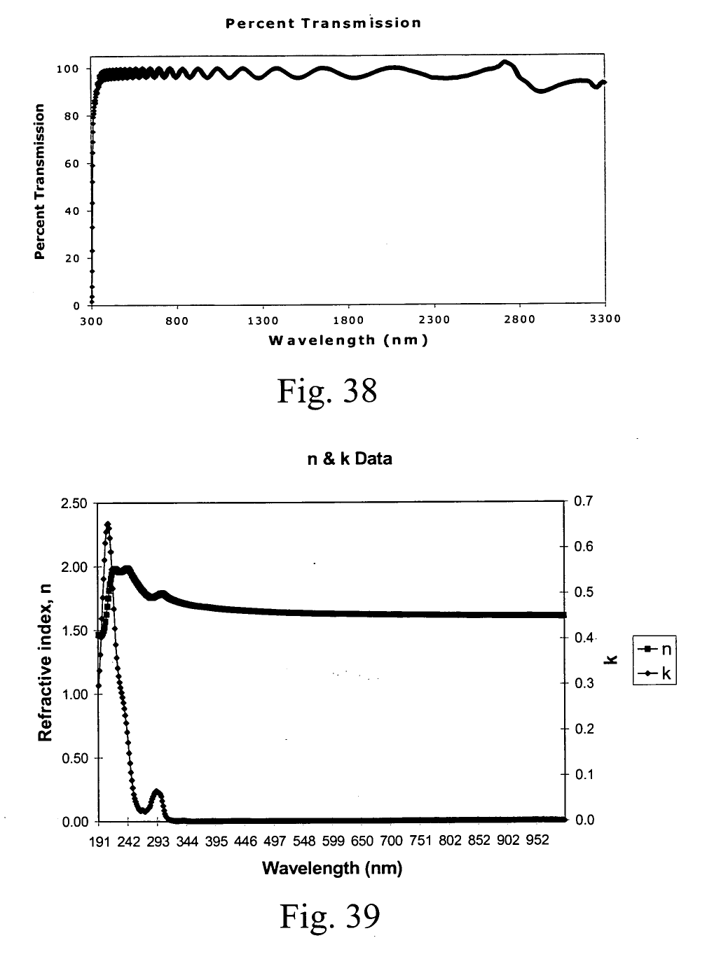

The transmission data of the films, shown in the graph of FIG. 38 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 18

### A Curable High Refractive Index Resin Prepared with a Brominated Epoxy Resin and a Brominated Epoxy Resin

### A. Preparation of Formulation 18

The following procedure was used to prepare a curable high refractive index coating:
1. First, 89.01 grams DENACOL EX-147 (Nagase ChemTex), 9.00 grams Dow D.E.R. 560, and 2.01 grams Dow UVI-6976 were measured into a 125-mL, brown Nalgene bottle.
2. The components were combined on a mixing wheel for 72 hours at 50 rpm.
   B. Preparation of Films from Formulation 18

Using normal spin-coating and UV-curing techniques, the formulation can be coated onto various types of wafers (silicon, quartz, glass, etc.). A CEE 100CB Spinner/Hotplate was used to apply Formulation 18 to wafers. Spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 14 minutes, and the total exposure doses was 2.3 J/cm².

Representative film processing data for these materials are shown in Table 35.

TABLE 35

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2.3 | 15.1838 |
| 2 | 2,000 | 4,500 | 60 | 2.3 | 7.4836 |
| 3 | 3,000 | 4,500 | 60 | 2.3 | 4.8222 |
| 4 | 4,000 | 4,500 | 60 | 2.3 | 3.6762 |
| 5 | 5,000 | 4,500 | 60 | 2.3 | 2.8356 |

The data of Table 36 were obtained through the analysis of the above films by using a prism coupler (Metricon 2010).

TABLE 36

| | Refractive Index | Refractive Index | Refractive Index |
|---|---|---|---|
| Wafer # | at 401 nm | at 633 nm | at 780 nm |
| 1 | 1.6690 | 1.6254 | 1.6163 |
| 2 | 1.6702 | 1.6256 | 1.6165 |
| 3 | 1.6711 | 1.6258 | 1.6178 |
| 4 | 1.6713 | 1.6271 | 1.6176 |
| 5 | 1.6713 | 1.6301 | 1.6179 |

The refractive index (n) and extinction coefficient (k) data (see FIG. 39) were obtained using a variable angle spectroscopic ellipsometer (VASE, M2000 VASE, J.A. Woollam Company).

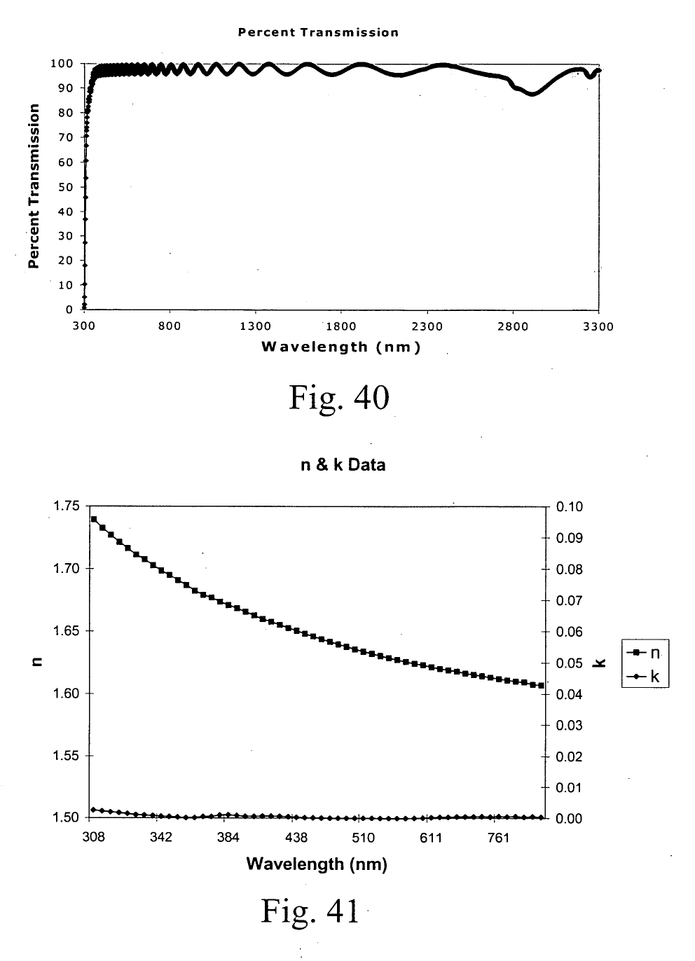

The transmission data of the films, shown in the graph of FIG. 40 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 19

### A Curable High Refractive Index Resin Prepared with a Brominated Epoxy Resin and an Aromatic Epoxy Diluent

### A. Preparation of Formulation 19

The following procedure was used to prepare a curable high refractive index coating:
1. An oil bath was preheated to 80° C. (oil temperature).
2. Approximately 29.13 grams of ERISYS GE-10 (CVC Chemical Specialties) were added to a 250-mL, round-bottom flask.
3. The flask and its contents were heated to about 60-70° C. while being stirred with a stir bar or mechanical stirrer.
4. Over a period of 2 hours, 69.00 grams Dow D.E.R. 560 were added to the ERISYS GE-10.
5. Dow UVI-6976 (The Dow Chemical Company) was added in an amount of 2% by weight, based upon the combined weight of the ingredients already added taken as 100% by weight.
6. The mixture was stirred for 3 hours.
7. The mixture was allowed to cool slightly and then poured into an appropriate container.
   B. Preparation of Films from formulation 19

Using normal spin-coating and UV-curing techniques, the formulation can be coated onto various types of wafers (silicon, quartz, glass, etc.). A CEE 100CB Spinner/Hotplate was used to apply Formulation 19 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 12 minutes, and the total exposure doses was 2 J/cm².

Representative film processing data for these materials are shown in Table 37.

TABLE 37

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 2 | 80 |
| 2 | 2,000 | 4,500 | 60 | 2 | 50 |
| 3 | 3,000 | 4,500 | 60 | 2 | 40 |
| 4 | 4,000 | 4,500 | 60 | 2 | 30 |
| 5 | 5,000 | 4,500 | 60 | 2 | 20 |

The data of Table 38 were obtained through the analysis of the above films by using a prism coupler (Metricon 2010).

TABLE 38

| | Refractive Index | Refractive Index | Refractive Index |
|---|---|---|---|
| Wafer # | at 401 nm | at 633 nm | at 780 nm |
| 1 | 1.6506 | 1.6076 | 1.6004 |
| 2 | 1.6506 | 1.6076 | 1.6002 |
| 3 | 1.6499 | 1.6077 | 1.5997 |
| 4 | 1.6495 | 1.6076 | 1.5997 |
| 5 | 1.6499 | 1.6077 | 1.5999 |

The refractive index (n) and extinction coefficient (k) data (see FIG. 41) were obtained using a variable angle spectroscopic ellipsometer (VASE, H-VASE, J.A. Woollam Company).

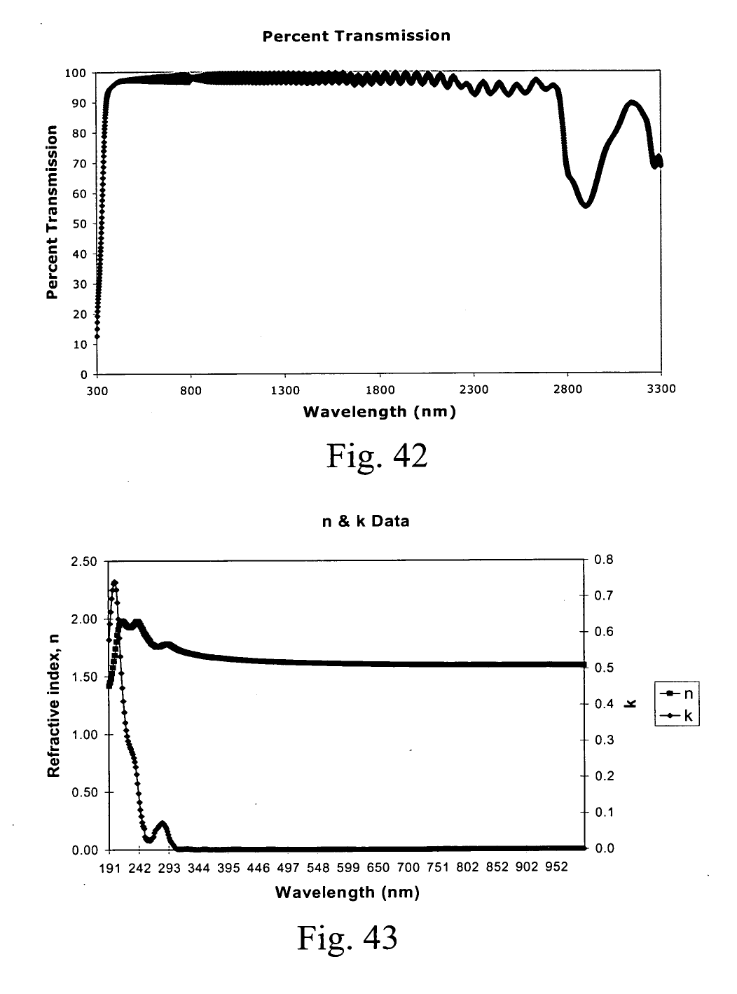

The transmission data of the films, shown in the graph of FIG. 42 and expressed as a percentage, were obtained using a Varian Gary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 20

### A Curable High Refractive Index Resin Prepared with an Epoxy Novolac Resin and a Brominated Epoxy Diluent

### A. Preparation of Formulation 20

The following procedure was used to prepare a curable high refractive index coating:
1. First, 79.10 grams of Dow D.E.N. 431, 19.04 grams of DENACOL EX-147 (Nagase ChemTex), and 2.01 grams Dow UVI-6976 were measured into a-125 mL, brown Nalgene bottle.
2. The components were combined on a mixing wheel for 72 hours at 50 rpm.
   B. Preparation of Films from Formulation 20

Using normal spin-coating and UV-curing techniques, the formulation can be coated onto various types of wafers (silicon, quartz, glass, etc.). A CEE 100CB Spinner/Hotplate was used to apply Formulation 20 to wafers. The spin speed was 1,000-5,000 rpm, the acceleration was 4,500 rpm/sec, and the spin time was 360 seconds.

A Canon PLA-501F Parallel Light Mask Aligner with xenon lamp was used to cure the films. The output was 2.7 mJ-sec/cm² at 365 nm, the time was 12 minutes, and the total exposure dose was 2 J/cm².

Representative film processing data for these materials are shown in fable 39.

TABLE 39

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 360 | 2.3 | 67.76 |
| 2 | 2,000 | 4,500 | 360 | 2.3 | 33.61 |
| 3 | 3,000 | 4,500 | 360 | 2.3 | 22.92 |
| 4 | 4,000 | 4,500 | 360 | 2.3 | 16.34 |
| 5 | 5,000 | 4,500 | 360 | 2.3 | 13.69 |

The data of Table 40 were obtained through the analysis of the above films by using a prism coupler (Metricon 2010).

TABLE 40

| | Refractive Index | Refractive Index | Refractive Index |
|---|---|---|---|
| Wafer # | at 401 nm | at 633 nm | at 780 nm |
| 1 | 1.6474 | 1.6044 | 1.5966 |
| 2 | 1.6473 | 1.6048 | 1.5966 |
| 3 | 1.6474 | 1.6048 | 1.5969 |
| 4 | 1.6474 | 1.6051 | 1.5967 |
| 5 | 1.6478 | 1.6048 | 1.5967 |

The refractive index (n) and extinction coefficient (k) data (see FIG. 43) were obtained using a variable angle spectroscopic ellipsometer (VASE, M2000 VASE, J.A. Woollam Company).

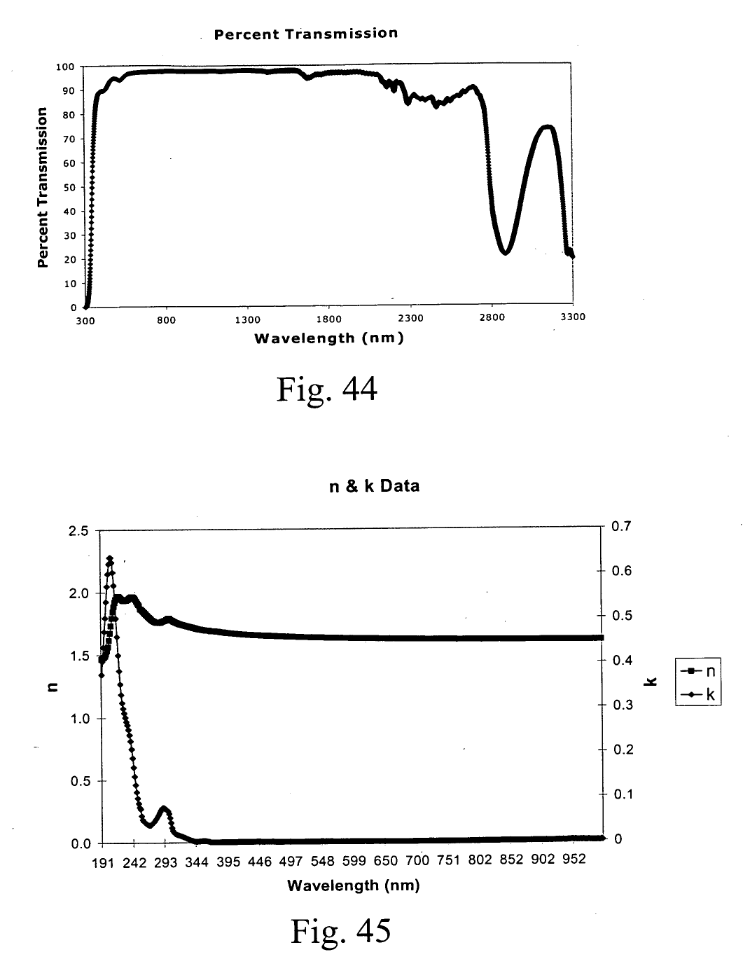

The transmission data of the films, shown in the graph of FIG. 44 and expressed as a percentage, were obtained using a Varian Cary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

### Example 21

### A Curable High Refractive Index Resin Prepared with a Brominated Epoxy Resin and an Epoxy Novolac Resin

### A. Preparation of Formulation 21

The following procedure was used to prepare a curable high refractive index coating:
1. First, 43.35 grams of DENACOL EX-147 (Nagase ChemTex), 3.33 grams of EPIKOTE 157 (Resolution Performance Products), and 3.76 grams DTS-102 (Midori Kagaku) were measured into a 125-mL, brown Nalgene bottle.
2. The components were combined on a mixing wheel for 96 hours at 50 rpm.
   B. Preparation of Films from Formulation 21

Using normal spin-coating and UV-curing techniques, the formulation can be coated onto various types of wafers (silicon, quartz, glass, etc). A CEE 100CB Spinner/Hotplate was used to apply formulation 21 to wafers. The spin speed was 1,000-5,000 rpm, the acceleration was 4,500 rpm/sec, and the spin time was 60 seconds.

A Canon PLA-501F Parallel Light Mask Aligner with xenon lamp was used to cure the films. The output was 2.7 mJ-sec/cm² at 365 nm, the time was 6 minutes, and the total exposure dose was 1 J/cm².

Representative film processing data for these materials are shown in Table 41.

TABLE 41

| | | | | Exposure | |
|---|---|---|---|---|---|
| | Spin Speed | Ramp Rate | Spin Time | Dose | Thickness |
| Wafer # | (rpm) | (rpm/sec) | (sec) | (J/cm²) | (μm) |
| 1 | 1,000 | 4,500 | 60 | 1 | 23.4 |
| 2 | 2,000 | 4,500 | 60 | 1 | 11.3 |
| 3 | 3,000 | 4,500 | 60 | 1 | 7.5 |
| 4 | 4,000 | 4,500 | 60 | 1 | 5.4 |
| 5 | 5,000 | 4,500 | 60 | 1 | 4.3 |

The data of Table 42 were obtained through the analysis of the above films by using a prism coupler (Metricon 2010).

TABLE 42

| | Refractive Index | Refractive Index | Refractive Index |
|---|---|---|---|
| Wafer # | at 401 nm | at 633 nm | at 780 nm |
| 1 | 1.67083 | 1.62453 | 1.61645 |
| 2 | 1.67181 | 1.62381 | 1.61453 |
| 3 | 1.66956 | 1.62374 | 1.61494 |
| 4 | 1.66887 | 1.62394 | 1.61459 |
| 5 | 1.66871 | 1.62394 | 1.61484 |

The refractive index (n) and extinction coefficient (k) data (See FIG. 45) were obtained using a variable angle spectroscopic ellipsometer (VASE, M2000 VASE, J.A. Woollam Company).

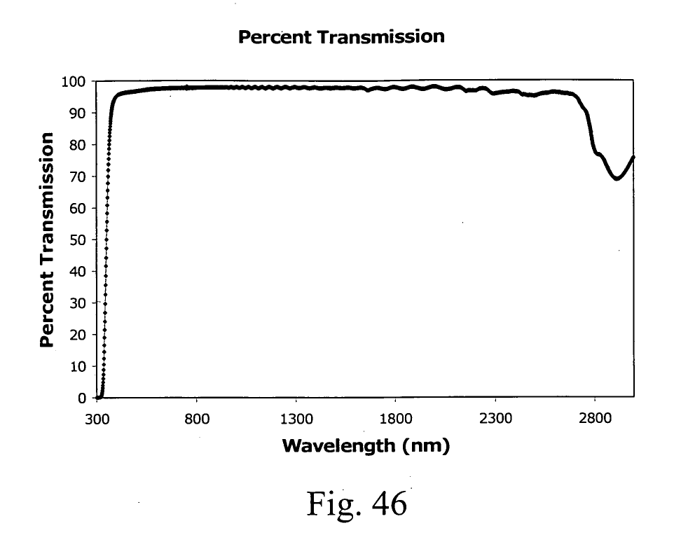

The transmission data of the films, shown in the graph of FIG. 46 and expressed as a percentage, were obtained using a Varian Cary 500 Scan UV-Vis-NIR Dual Beam Spectrophotometer. The mode used was nanometers, with a range of 300-3,300 nm. For the scan controls, the average time was 0.1 second, the data interval was 1.0 nm, and the scan rate was 600 nm/min. The Y mode parameters were Y min= 0.00, and Y max= 100.00. The baseline parameter was zero/baseline.

1. A composition useful for fabricating optoelectronic components, said composition comprising a mixture of:
a compound having a formula selected from the group consisting of 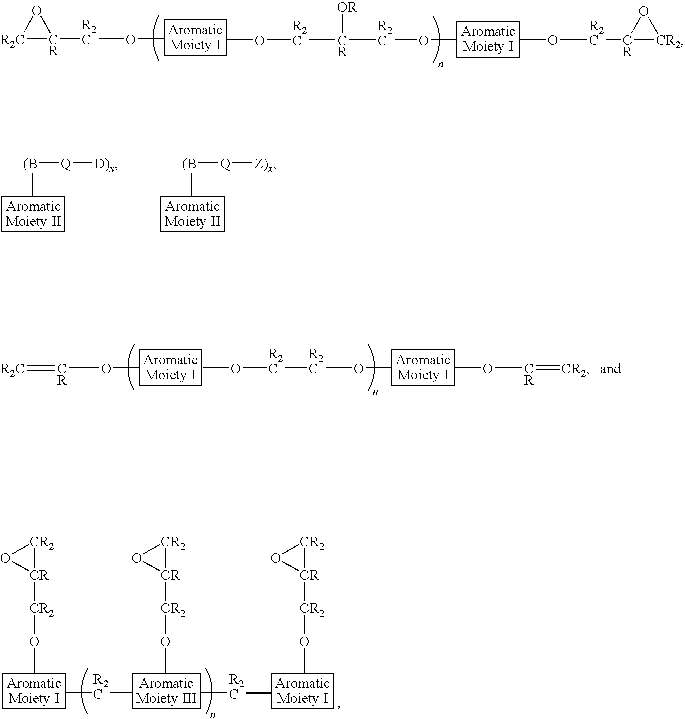
where:
each R is individually selected from the group consisting of hydrogen, alkyls, alkoxys, cycloaliphatics, and aromatics;
each B is individually selected from the group consisting of —CO—, —COO—. —CON—, —O—, —S—, —SO—, —SO₄—, —CR₂—, and —NR—;
each Q is individually selected from the group consisting of —CR₂;
each D is individually selected from the group consisting of —VCRCR₂, where V is selected from the group consisting of —O— and —S—; each Z is individually selected from the group consisting of 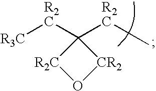
x is from about 0-6; and
n is from about 0-100; and
each Aromatic Moiety I is individually selected from the group consisting of 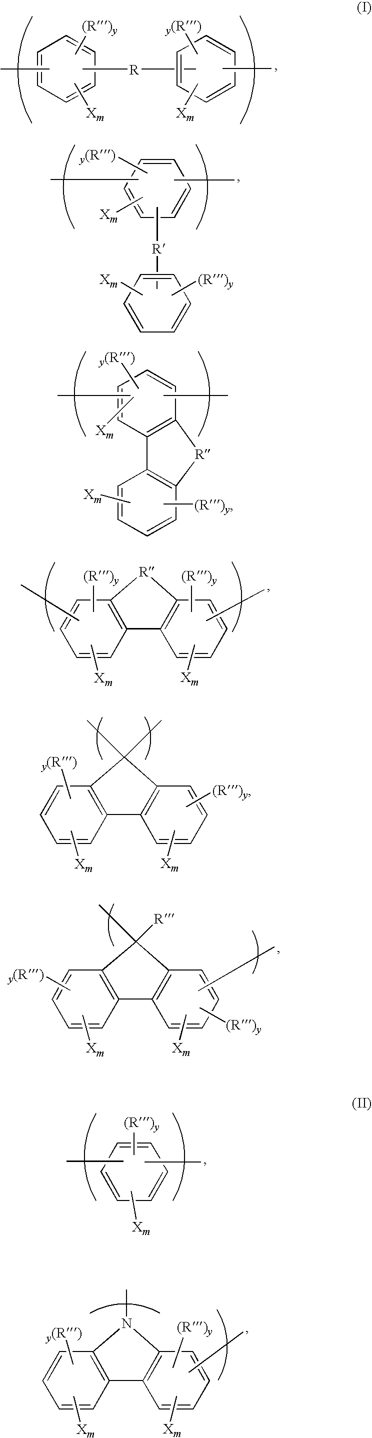 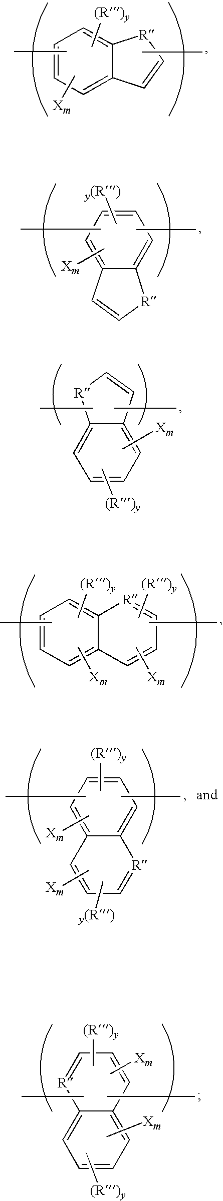
each Aromatic Moiety II is individually selected from the group consisting of 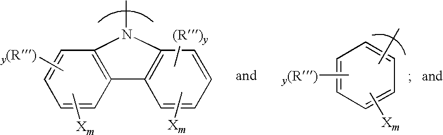
each Aromatic Moiety III is individually selected from the group consisting of 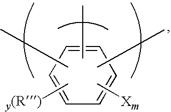
where:
each R′ is individually selected from the group consisting of —C(CR′″₃)₂—, —CR′″₂—, —SO₂—, —S—, —SO—, and —CO—, where each R′″ is individually selected from the group consisting of hydrogen, alkyls, alkoxys, cycloaliphatics, and aromatics:
each R″ is individually selected from the group consisting of —CR′″₂—, —SO₂—, —SO—, —S—, —O—, —CO—, and —NR′″—, where each R′″ is individually selected from the group consisting of hydrogen, alkyls, alkoxys, cycloaliphatics, and aromatics:
each X is individually selected from the group consisting of the halogens:
each m is individually selected from the group consisting of 0-6; and each y is individually selected from the group consisting of 0-6, when said compound comprises a moiety selected from the group consisting of (I), (II), and aromatic moiety III, X is present at sufficient levels to provide at least about 1% by weight of X, based upon the total weight of the composition taken as 100% by weight; and
a crosslinking catalyst,
wherein said composition comprises less than about 5% by weight of non-reactive solvent, based upon the total weight of the composition taken as 100% by weight.

2. (canceled)

3. The composition of claim 1, where R is hydrogen.

4. The composition of claim 1, said mixture further comprising a compound having a formula selected from the group consisting of 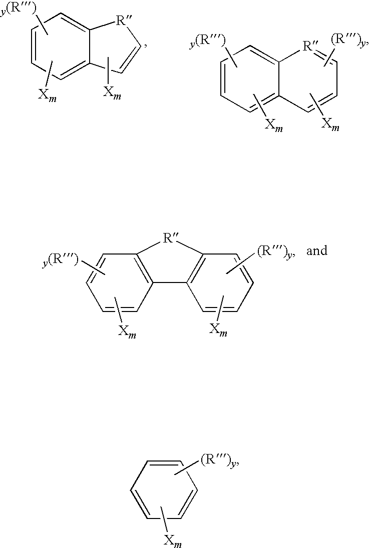
where:
each R″ is individually selected from the group consisting of —CR′″₂—, —SO₂—, —SO—, —S—, —O—, —CO—, and —NR′″—, where each R′″ is individually selected from the group consisting of hydrogen, alkyls, alkoxys, cycloaliphatics, and aromatics;
each X is individually selected from the group consisting of the halogens;
each m is individually selected from the group consisting of 0-6; and
each y is individually selected from the group consisting of 0-6.

5. The composition of claim 1, wherein said crosslinking catalyst is selected from the group consisting of acids, photoacid generators, photobases, thermal acid generators, thermal base generators, and mixtures thereof.

6. A method of forming an optoelectronic component, said method comprising the step of applying a composition to a substrate so as to form a layer of said composition on said substrate, said composition comprising a mixture of:
a compound having a formula selected from the group consisting of 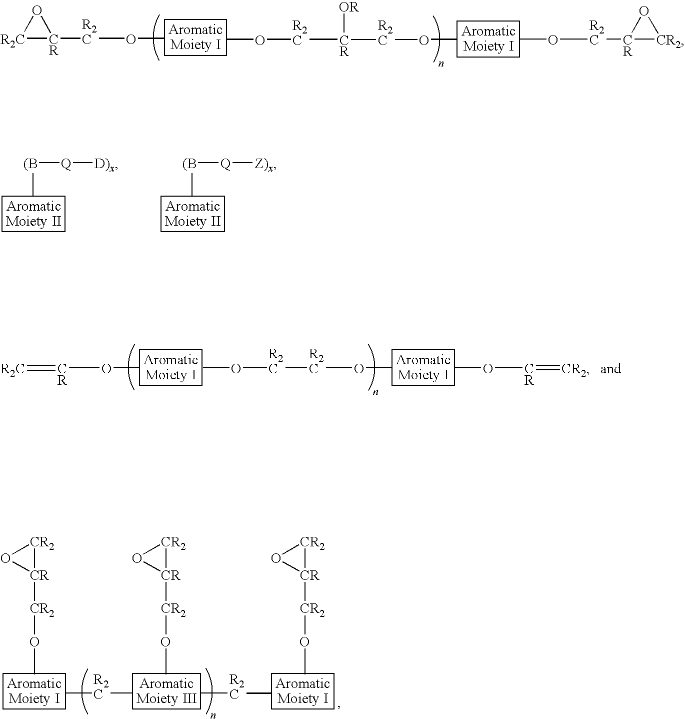
where:
each R is individually selected from the group consisting of hydrogen, alkyls, alkoxys, cycloaliphatics, and aromatics;
each B is individually selected from the group consisting of —CO—, —COO—, —CON—, —O—, —S—, —SO—, —SO₂—, —CR₂—, and —NR—;
each Q is individually selected from the group consisting of —CR₂;
each D is individually selected from the group consisting of —VCRCR₂, where V is selected from the group consisting of —O— and —S—;
each Z is individually selected from the group consisting of 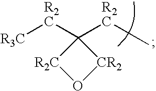
x is from about 0-6; and
n is from about 0-100; and
each Aromatic Moiety I is individually selected from the group consisting of 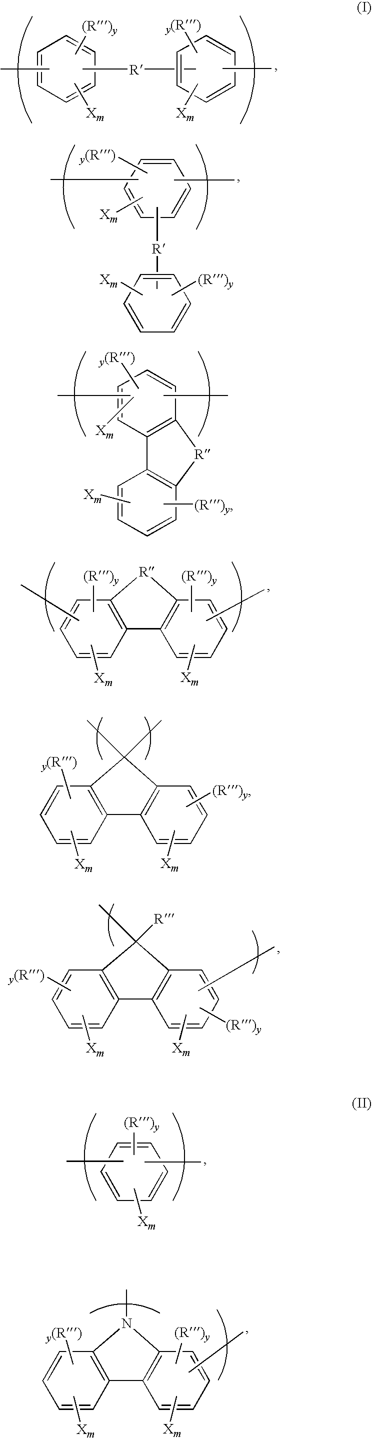 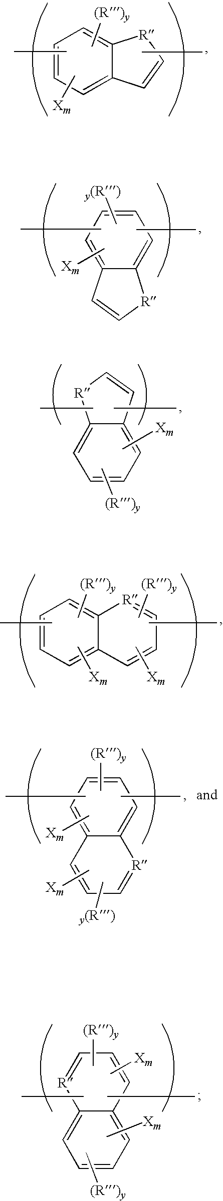
each Aromatic Moiety II is individually selected from the group consisting of 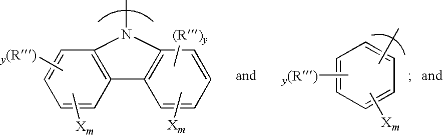
each Aromatic Moiety III is individually selected from the group consisting of 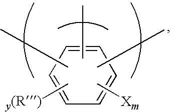
where:
each R′ is individually selected from the group consisting of —C(CR′″₃)₂—, —CR′″₂—, —SO₂—, —S—, —SO—, and —CO—, where each R′″ is individually selected from the group consisting of hydrogen, alkyls, alkoxys, cycloaliphatics, and aromatics:
each R″ is individually selected from the group consisting of —CR′″₂—, —SO₃—, —SO—, —S—, —O—, —CO—, and —NR′″—, where each R′″ is individually selected from the group consisting of hydrogen, alkyls, alkoxys, cycloaliphatics, and aromatics;
each X is individually selected from the group consisting of the halogens;
each m is individually selected from the group consisting of 0-6; and
each y is individually selected from the group consisting of 0-6; and
when said compound comprises a moiety selected from the group consisting of (I), (II), and aromatic moiety III, X is present at sufficient levels to provide at least about 1% by weight of X, based upon the total weight of the composition taken as 100% by weight; and
a crosslinking catalyst,
wherein said composition comprises less than about 5% by weight of non-reactive solvent, based upon the total weight of the composition taken as 100% by weight.

7. The method of claim 6, wherein said substrate is selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide, glass, quartz, polycarbonates, polyesters, acrylics, polyurethanes, papers, ceramics, and metals.

8. The method of claim 6, further comprising the step of curing said layer.

9. The method of claim 8, wherein said curing step comprises heating said composition to a temperature of at least about 40° C. for at least about 5 seconds.

10. The method of claim 8, wherein said curing step comprises exposing said layer to light at a wavelength effective for curing said layer.

11. The method of claim 8, wherein said cured layer has a refractive index of at least about 1.5 at a wavelength of from about 375-1,700 nm.

12. The method of claim 8, wherein said cured layer has a percent transmittance of at least about 80% of light at a wavelengths of from about 375-1,700 nm and at a film thickness of about 100 μm.

13. (canceled)

14. The method of claim 6, where R is hydrogen.

15. The method of claim 6, said mixture further comprising a compound having a formula selected from the group consisting of 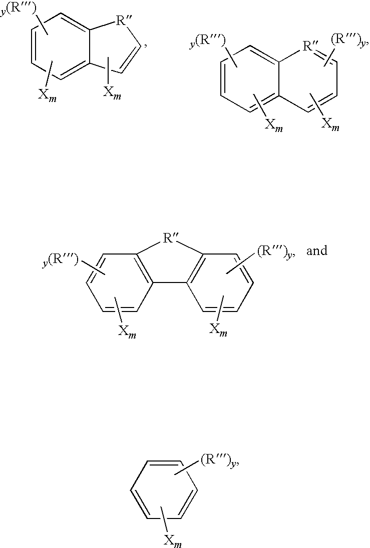
where:
each R″ is individually selected from the group consisting of —CR′″₂—, SO₂—, —SO—, —S—, —O—, —CO—, and —NR′″—, where each R′″ is individually selected from the group consisting of hydrogen, alkyls, alkoxys, cycloaliphatics, and aromatics;
each X is individually selected from the group consisting of the halogens;
each m is individually selected from the group consisting of 0-6; and
each y is individually selected from the group consisting of 0-6.

16. The method of claim 6, wherein said crosslinking catalyst is selected from the group consisting of acids, photoacid generators, photobases, thermal acid generators, thermal base generators, and mixtures thereof.

17. A method of forming an optoelectronic component, said method comprising the step of applying a composition to a substrate so as to form a layer of said composition on said substrate;
said composition comprising a compound having a formula selected from the group consisting of 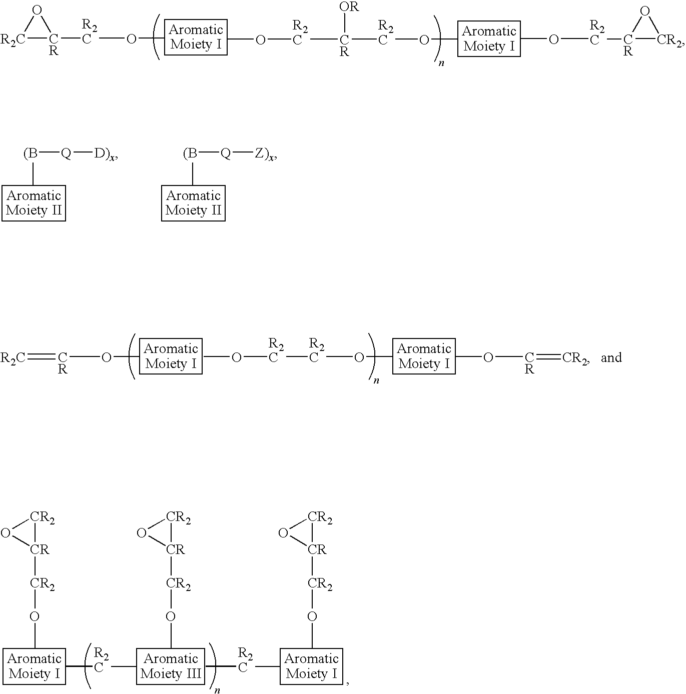
where:
each R is individually selected from the group consisting of hydrogen, alkyls, alkoxys, cycloaliphatics, and aromatics;
each B is individually selected from the group consisting of —CO—, —COO—, —CON—, —O—, —S—, —SO—, —SO₂—, —CR₂—, and —NR—;
each Q is individually selected from the group consisting of —CR₂;
each D is individually selected from the group consisting of —VCRCR₂, where V is selected from the group consisting of —O— and —S—;
each Z is individually selected from the group consisting of 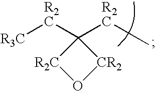
x is from about 0-6; and
n is from about 0-100; and
each Aromatic Moiety I is individually selected from the group consisting of 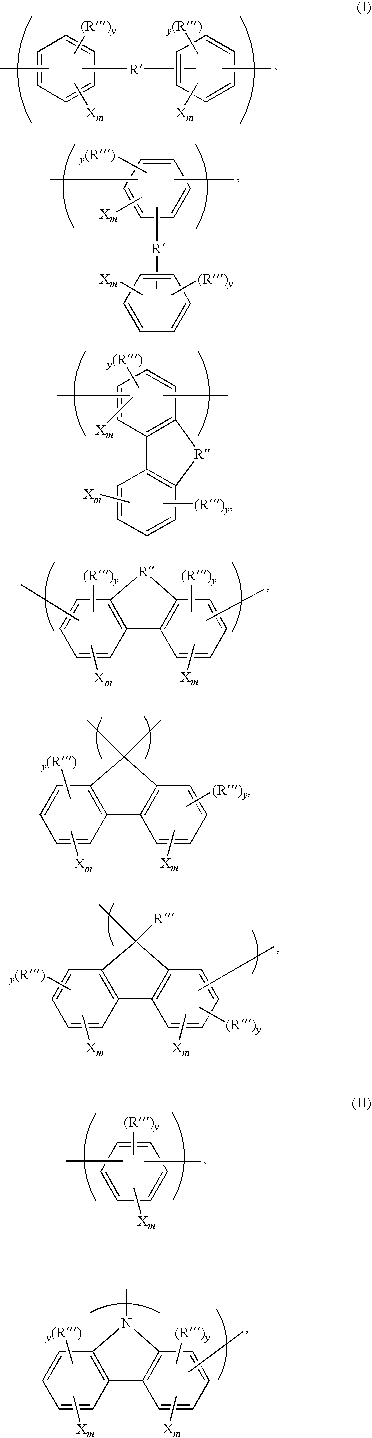 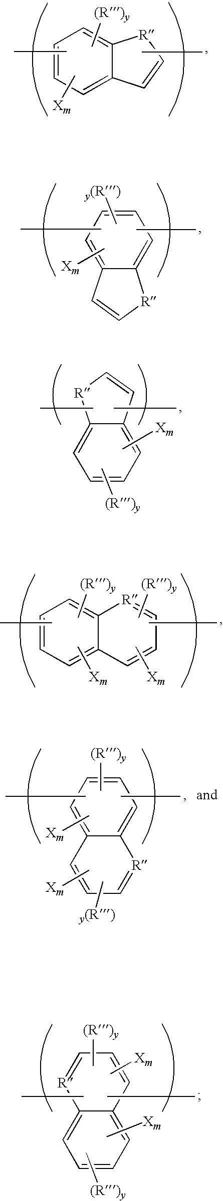
each Aromatic Moiety II is individually selected from the group consisting of 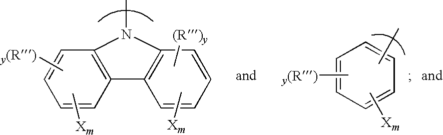
each Aromatic Moiety III is individually selected from the group consisting of 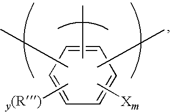
where:
each R′ is individually selected from the group consisting of —C(CR′″₃)₂—, —CR′″₂—, —SO₂—, —S—, —SO—, and —CO—, where each R′″ is individually selected from the group consisting of hydrogen, alkyls, alkoxys, cycloaliphatics, and aromatics;
each R″ is individually selected from the group consisting of —CR′″₂—, —SO₂—, —SO—, —S—, —O—, —CO—, and —NR′″, where each R′″ is individually selected from the group consisting of hydrogen, alkyls, alkoxys, cycloaliphatics, and aromatics:
each X is individually selected from the group consisting of the halogens:
each m is individually selected from the group consisting of 0-6; d
each y is individually selected from the group consisting of 0-6, when said compound comprises a moiety selected from the group consisting of (I), (II), and aromatic moiety III, X is present at sufficient levels to provide at least about 1% by weight of X, based upon the total weight of the composition taken as 100% by weight; and
said substrate being selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide, glass, quart/, polycarbonates, polyesters, acrylics, polyurethanes, papers, ceramics, and metals.

18. The method of claim 17, further comprising the step of curing said layer.

19. The method of claim 18, wherein said curing step comprises heating said composition to a temperature of at least about 40° C. for at least about 5 seconds.

20. The method of claim 18, wherein said curing step comprises exposing said layer to light at a wavelength effective for curing said layer.

21. The method of claim 18, wherein said cured layer has a refractive index of at least about 1.5 at a wavelength of from about 375-1.700 nm.

22. The method of claim 18, wherein said cured layer has a percent transmittance of at least about 80% of light at a wavelengths of from about 375-1,700 nm and at a film thickness of about 100 μm.

23. The method of claim 17, said composition further comprising a crosslinking catalyst.

24. The method of claim 23, wherein said crosslinking catalyst is selected from the group consisting of acids, photoacid generators, photobases, thermal acid generators, thermal base generators, and mixtures thereof.

25. The method of claim 17, wherein said composition comprises less than about 5% by weight of non-reactive solvent, based upon the total weight of the composition taken as 100% by weight.

26. (canceled)

27. The method of claim 17, where R is hydrogen.

28. The method of claim 17, said mixture further comprising a compound having a formula selected from the group consisting of 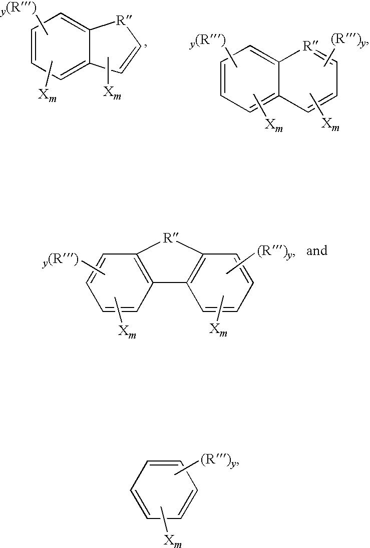
where:
each R″ is individually selected from the group consisting of —CR′″₂—, —SO₂—, —SO—, —S—, —O—, —CO—, and —NR′″—, where each R′″ is individually selected from the group consisting of hydrogen, alkyls, alkoxys, cycloaliphatics, and aromatics:
each X is individually selected from the group consisting of the halogens;
each m is individually selected from the group consisting of 0-6; and
each y is individually selected from the group consisting of 0-6.

29. The combination of:
a substrate having a surface; and
a layer of a composition on said substrate surface, said composition comprising a mixture of:
a compound having a formula selected from the group consisting of 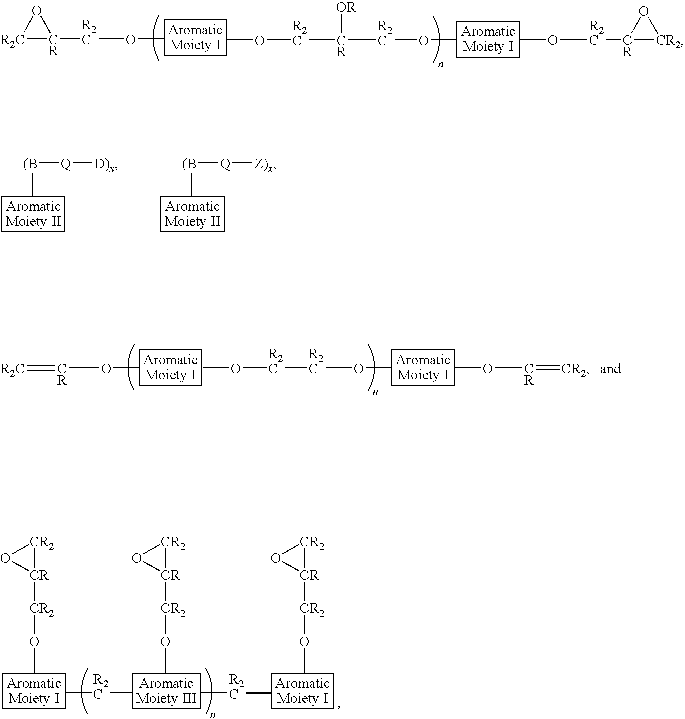
where:
each R is individually selected from the group consisting of hydrogen, alkyls, alkoxys, cycloaliphatics, and aromatics;
each B is individually selected from the group consisting of —CO—, —COO—, —CON—, —O—, —S—, —SO—, —SO₂—, —CR₂—, and —NR—;
each Q is individually selected from the group consisting of —CR₂;
each D is individually selected from the group consisting of —VCRCR₂, where V is selected from the group consisting of —O— and —S—;
each Z is individually selected from the group consisting of 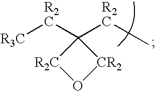
x is from about 0-6; and
n is from about 0-100;
each Aromatic Moiety I is individually selected from the group consisting of 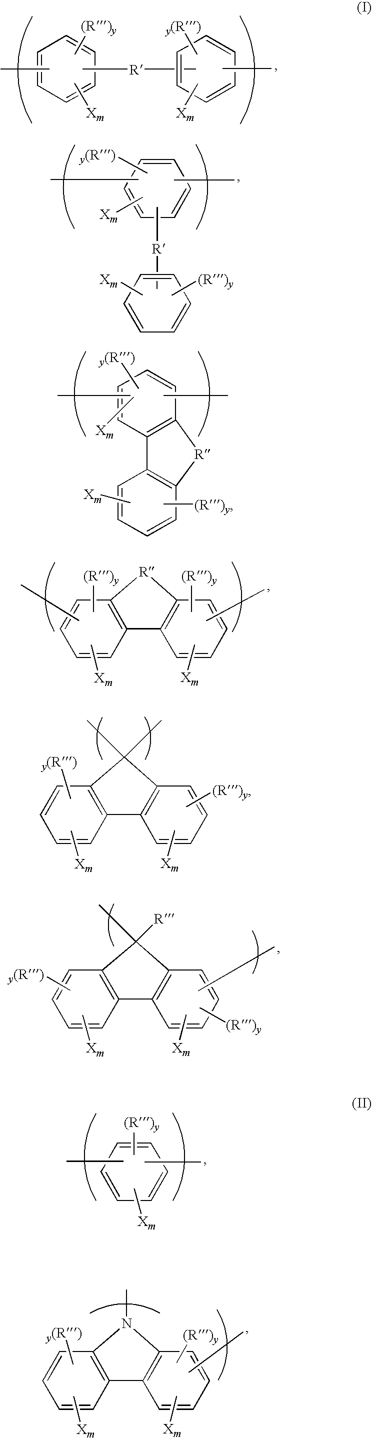 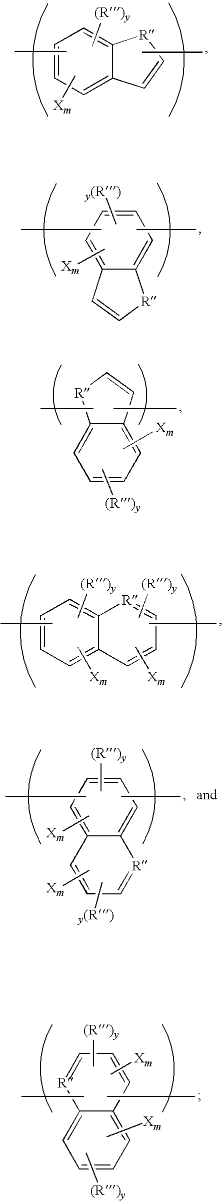
each Aromatic Moiety II is individually selected from the group consisting of 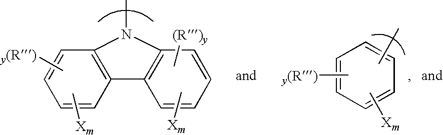
each Aromatic Moiety III is individually selected from the group consisting of 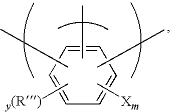
where:
each R′ is individually selected from the group consisting of —C(CR′″₃)₂—, —CR′″₂, —SO₂, —S—, —SO—, and —CO—, where each R′″ is individually selected from the group consisting of hydrogen, alkyls, alkoxys, cycloaliphatics, and aromatics;
each R″ is individually selected from the group consisting of —CR′″₂. —SO₂—, —SO—, —S—, —O—, —CO—, and —NR′″—, where each R′″ is individually selected from the group consisting of hydrogen, alkyls, alkoxys, cycloaliphatics, and aromatics;
each X is individually selected from the group consisting of the halogens:
each m is individually selected from the group consisting of 0-6; and
each y is individually selected from the group consisting of 0-6; and
when said compound comprises a moiety selected from the group consisting of (I), (II), and aromatic moiety III, X is present at sufficient levels to provide at least about 1% by weight of X, based upon the total weight of the composition taken as 100% by weight; and
a crosslinking catalyst,
wherein said composition comprises less than about 5% by weight of non-reactive solvent, based upon the total weight of the composition taken as 100% by weight.

30. The combination of claim 29, wherein said substrate is selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide, glass, quartz, polycarbonates, polyesters, acrylics, polyurethanes, papers, ceramics, and metals.

31. (canceled)

32. The combination of:
a substrate having a surface; and
a layer of a composition on said substrate surface, said composition comprising a compound having a formula selected from the group consisting of 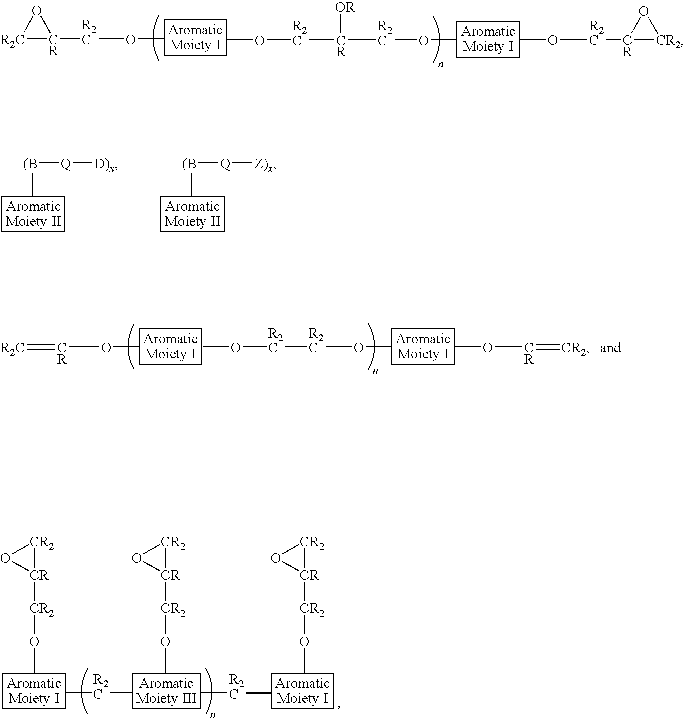
where:
each R is individually selected from the group consisting of hydrogen, alkyls, alkoxys, cycloaliphatics, and aromatics;
each B is individually selected from the group consisting of —CO—. —COO—, —CON—, —O—, —S—, —SO—, —SO₂—, —CR₂—, and —NR—;
each Q is individually selected from the group consisting of —CR₂;
each D is individually selected from the group consisting of —VCRCR₂, where V is selected from the group consisting of —O— and —S—;
each Z is individually selected from the group consisting of 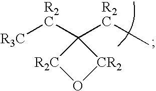
x is from about 0-6; and
n is from about 0-100; and
each Aromatic Moiety I is individually selected from the group consisting of 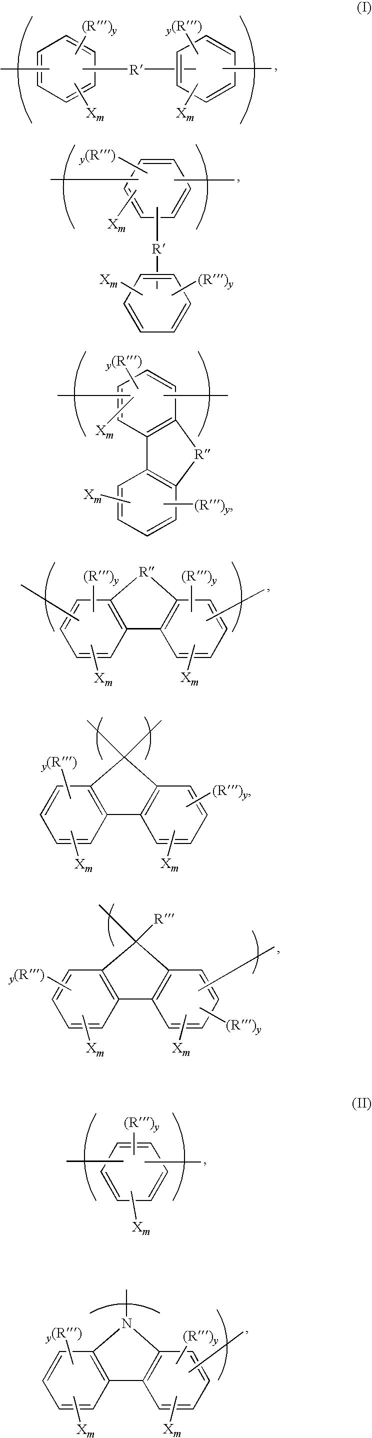 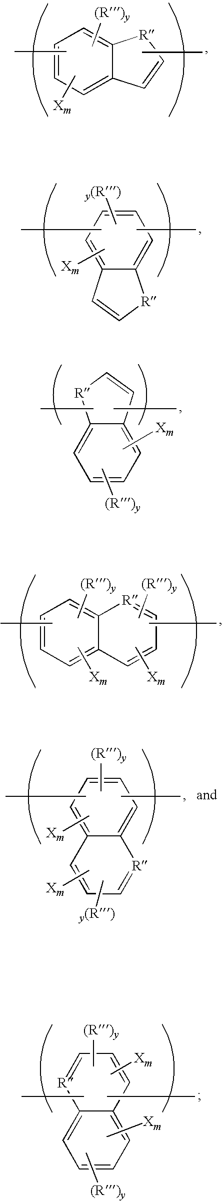
each Aromatic Moiety II is individually selected from the group consisting of 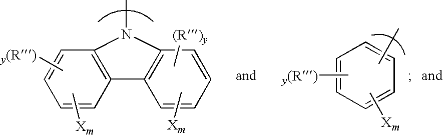
each Aromatic Moiety III is individually selected from the group consisting of 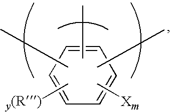
where:
each R′ is individually selected from the group consisting of —C(CR′″₃)₂—, —CR′″₂—, —SO₂—, —S—, —SO—, and —CO—, where each R′″ is individually selected from the group consisting of hydrogen, alkyls, alkoxys, cycloaliphatics, and, aromatics:
each R″ is individually selected from the group consisting of —CR′″₂—, —SO₂—, —SO—, —S—, —O—, —CO—, and —NR′″—, where each R′″ is individually selected from the group consisting of hydrogen, alkyls, alkoxys, cycloaliphatics, and aromatics:
each X is individually selected from the group consisting of the halogens:
each m is individually selected from the group consisting of 0-6; and
each y is individually selected from the group consisting of 0-6; and
when said compound comprises a moiety selected from the group consisting of (I), (II), and aromatic moiety III, X is present at sufficient levels to provide at least about 1% by weight of X, based upon the total weight of the composition taken as 100% by weight; and
said substrate being selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide, glass, quartz, polycarbonates, polyesters, acrylics, polyurethanes, papers, ceramics, and metals.

33. The combination of claim 32, said composition further comprising a crosslinking catalyst.

34. The combination of claim 33, wherein said crosslinking catalyst is selected from the group consisting of acids, photoacid generators, photobases, thermal acid generators, thermal base generators, and mixtures thereof.

35. The combination of claim 32, wherein said composition comprises less than about 5% by weight of non-reactive solvent, based upon the total weight of the composition taken as 100% by weight.

36. (canceled)

37. The combination of:
a substrate having a surface; and
a cured layer of a composition on said substrate surface, said cured layer comprising crosslinked compounds having a formula selected from the group consisting of 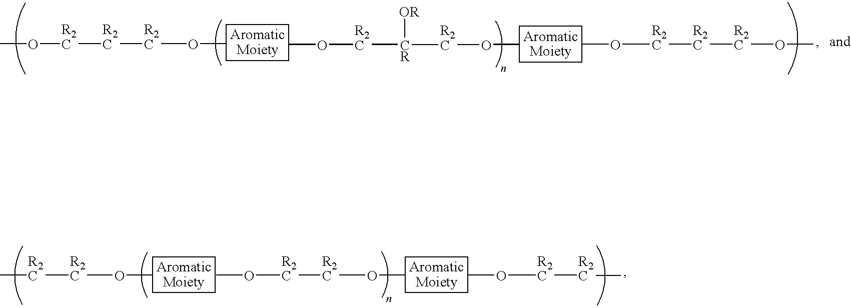
where:
each R is individually selected from the group consisting of hydrogen, alkyls, alkoxys, cycloaliphatics, and aromatics; and
n is from about 0-100;
each Aromatic Moiety I is individually selected from the group consisting of 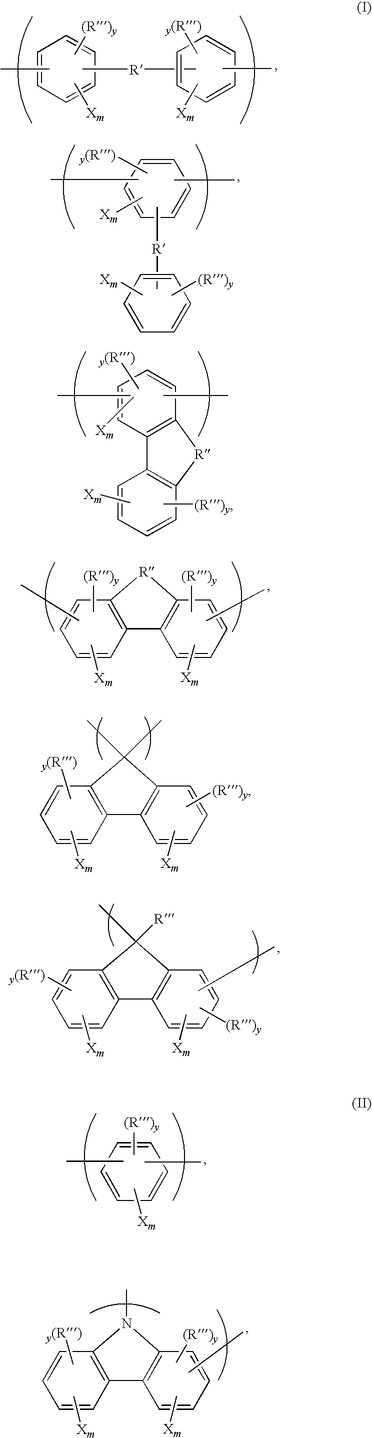 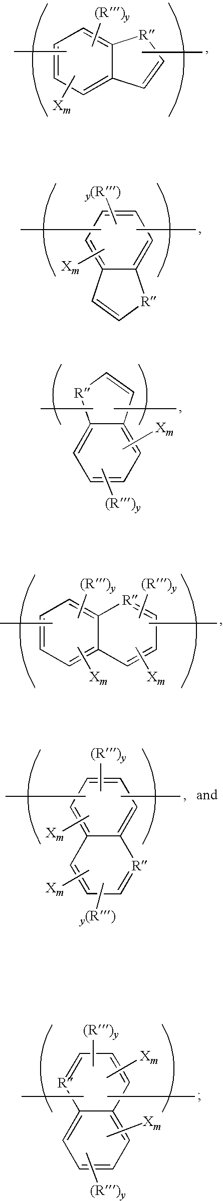
where:
each R′ is individually selected from die group consisting of —C(CR′″₃)₂—, —CR′″₂—, —SO₂—, —S—, —SO—, and —CO—, where each R′″ is individually selected from the group consisting of hydrogen, alkyls, alkoxys, cycloaliphatics, and aromatics;
each R″ is individually selected from the group consisting of —CR′″₂—, —SO₂—, —SO—, —S—, —O—, —CO—, and —NR′″—, where each R′″ is individually selected from the group consisting of hydrogen, alkyls, alkoxys, cycloaliphatics, and aromatics;
each X is individually selected from the group consisting of the halogens;
each m is individually selected from the group consisting of 0-6:
each y is individually selected from the group consisting of 0-6; and
when said compound comprises a moiety selected from the group consisting of (I), (II), and aromatic moiety III, X is present at sufficient levels to provide at least about 1% by weight of X, based upon the total weight of the composition taken as 100% by weight; and
said cured layer having a refractive index of at least about 1.5 at a wavelength of from about 375-1,700 nm.

38. The combination of claim 37, said substrate being selected from the group consisting of silicon, silicon dioxide, silicon nitride, aluminum gallium arsenide, aluminum indium gallium phosphide, gallium nitride, gallium arsenide, indium gallium phosphide, indium gallium nitride, indium gallium arsenide, aluminum oxide, glass, quartz, polycarbonates, polyesters, acrylics, polyurethanes, papers, ceramics, and metals.

39. (canceled)
